(19) United States
(12) Patent Application Publication
(10) Pub. No.: US 2022/0228992 A1
(43) Pub. Date: Jul. 21, 2022

(54) SUBSTRATES FOR SURFACE-ENHANCED RAMAN SPECTROSCOPY AND METHODS FOR MANUFACTURING SAME

(71) Applicant: The Research Foundation for The State University of New York, Buffalo, NY (US)

(72) Inventors: Qiaoqiang GAN, East Amherst, NY (US); Nan ZHANG, Buffalo, NY (US); Haomin SONG, Williamsville, NY (US)

(21) Appl. No.: 17/609,454

(22) PCT Filed: May 6, 2020
(86) PCT No.: PCT/US20/31733

§ 371 Date: Nov. 8, 2021

Related U.S. Application Data
(60) Provisional application No. 62/844,120, filed on May 6, 2019.

(51) Int. Cl. G01N 21/65; G01N 21/552; B82Y 15/00; B82Y 30/00; B82Y 40/00

(52) U.S. Cl. CPC G01N 21/658; G01N 21/554; G01N 2021/655; B82Y 30/00; B82Y 40/00; B82Y 15/00

(57) ABSTRACT

Structures and methods for Surface-Enhanced Raman Spectroscopy (SERS) are presented. In some embodiments, a SERS structure includes a ground plate with a spacer layer disposed thereon. A first plurality of metallic nanostructures is disposed on the spacer layer such that a portion of the spacer layer is exposed in gaps formed between the nanostructures of the first plurality of metallic nanostructures. In some embodiments, a first metallic layer is annealed to form the first plurality of metallic nanostructures. A second plurality of metallic nanostructures is disposed on the spacer layer in the gaps of the first plurality of metallic nanostructures. In some embodiments, a second metallic layer is annealed to form the second plurality of metallic nanostructures.

### CROSS REFERENCE TO RELATED APPLICATIONS

This application claims priority to U.S. Provisional Application No. 62/844,120, filed on May 6, 2019, the entire disclosure of which is hereby incorporated by reference.

### STATEMENT REGARDING FEDERALLY SPONSORED RESEARCH

This invention was made with government support under contract no. 1562057 awarded by the National Science Foundation. The government has certain rights in the invention.

### FIELD OF THE DISCLOSURE

The disclosure generally relates to structures for use in spectroscopy.

### BACKGROUND OF THE DISCLOSURE

Surface-enhanced Raman spectroscopy (SERS) refers to a vibrational spectroscopic technique capable of enhancing the weak and inelastic Raman scattering of low concentration analytes bound to or near patterned metallic surfaces. Utilizing this sensing technology, glucose, oligonucleotides, explosives, and other analytes of interest have been detected. Recently, the unprecedented ability of nanoplasmonic/metamaterial structures to concentrate light has attracted significant research interest. It has been reported that an optical field can be concentrated into deep-subwavelength volumes and realize significant localized-field enhancement (“hot spot”) using a variety of nanoantenna structures (e.g., nanoparticle/sphere array, bow-tie nano-antennas, nano-rods, etc.). However, due to the diffraction limit of conventional optics, the light coupling efficiency from free-space into deep-subwavelength volumes is usually very weak. Furthermore, current dominant fabrication techniques are expensive and complicated to fabricate high quality SERS substrates over large areas, thus resulting in high prices for commercial SERS substrates.

A technical barrier for SERS is its randomness of the localized field for sensing signal. Therefore, although SERS is among the most sensitive optical technology, its commercial application is limited. A major issue is the randomness of the distribution in localized field enhancement, even in periodic patterned structures. SERS was mainly used for qualitative sensing rather than quantitative sensing. To enable quantitative sensing, uniform distribution of enhanced optical field is required.

High performance sensor chips for SERS mainly relying on periodically patterned metallic nanostructures. However, their price is very high (e.g., >$100/piece with an area of 3 mm×3 mm or 5 mm×5 mm). The enhancement factor for commercial available chips varies in a wide range. In particular, most of them have to work with expensive desk top Raman microscope. Due to the emerging commercialization of portable Raman spectroscopy systems, low cost and high performance SERS chips are required to enable portable SERS sensing.

More specifically, plasmonic nanostructures with highly controlled ultrasmall nanogaps can generate stronger SERS signals from molecules in the nanogap. Most importantly, reliability, shelf time and uniformity are major challenges for most metallic nanostructures for SERS sensing. Due to the randomness of the localized field supported by silver and gold nanopatterns in conventional structures, the quantitative analysis of the target in the practical application of SERS sensing is a challenge.

Therefore, improved means for performing SERS are needed.

### SUMMARY OF THE DISCLOSURE

In an embodiment, a method for manufacturing a substrate for Surface-Enhanced Raman Spectroscopy (SERS) may comprise providing a ground plate. A spacer layer may be provided on the ground plate. A first plurality of metallic nanostructures may be formed on the spacer layer such that a portion of the spacer layer is exposed in gaps formed between the nanostructures of the first plurality of metallic nanostructures. A second plurality of metallic nanostructures may be formed on the spacer layer in the gaps of the first plurality of metallic nanostructures.

Forming the first plurality of metallic nanostructures on the spacer layer may comprise depositing a first metallic layer on the spacer layer and annealing the first metallic layer. The first metallic layer may be at a temperature such that the first metallic layer is transformed into the first plurality of metallic nanostructures disposed on the spacer layer thereby exposing a portion of the spacer layer. The first metallic layer may comprise silver. The temperature may be 200° C.

Forming the first plurality of metallic nanostructures on the spacer layer may comprise depositing the first plurality of nanostructures on the spacer layer to an average thickness ranging from 5 nm to 8 nm, inclusive.

Forming the second plurality of metallic nanostructures may comprise depositing a second metallic layer on the first plurality of metallic nanostructures and the exposed portion of the spacer layer. The second metallic layer may be annealed at a temperature such that the second metallic layer is transformed into the second plurality of metallic nanostructures disposed in the gaps of the first plurality of nanostructures. The second metallic layer may comprise gold and the temperature may be 150° C.

In another embodiment, a structure for Surface-Enhanced Raman Spectroscopy (SERS) may comprise a ground plate, a spacer layer disposed on the ground plate, a first plurality of metallic nanostructures disposed on the spacer layer such that a portion of the spacer layer is exposed in gaps formed between the nanostructures of the first plurality of metallic nanostructures, and a second plurality of metallic nanostructures disposed on the spacer layer in the gaps of the first plurality of metallic nanostructures.

In another embodiment, a SERS system may comprise a structure for Surface-Enhanced Raman Spectroscopy (SERS), which may comprise a ground plate, a spacer layer disposed on the ground plate, a first plurality of metallic nanostructures disposed on the spacer layer such that a portion of the spacer layer is exposed in gaps formed between the nanostructures of the first plurality of metallic nanostructures, and a second plurality of metallic nanostructures disposed on the spacer layer in the gaps of the first plurality of metallic nanostructures. The structure may be configured for the detection of a drug or a virus. The structure may be configured as a flow-through sensor.

In another embodiment, a method for manufacturing a SERS nanostructure may comprise forming a first plurality of metallic nanostructures on a substrate such that a portion of the substrate is exposed in gaps formed between the nanostructures of the first plurality of metallic nanostructures. The first plurality of metallic nanostructures may be conformally coated with a spacer layer. A metallic layer may be deposited on the spacer layer.

Forming the first plurality of metallic nanostructures may comprise depositing a metal on the substrate. The deposited metal may be annealed at a temperature to form the first plurality of metallic nanostructures. The metal may be deposited to an average thickness from 10 nm to 15 nm, inclusive. Depositing the metal on the substrate may comprise electron-beam evaporation. The temperature may be 300° C.

The method may further comprise template stripping the SERS nanostructure from the substrate. Template stripping the SERS nanostructure from the substrate may comprise applying a UV-curable optical adhesive to the metallic layer. The UV-curable optical adhesive may be covered with a glass slide. The UV-curable optical adhesive may be cured. The SERS nanostructure may be removed from the substrate.

The spacer layer may have an average thickness less than 2 nm. The average thickness of the spacer layer may be from 0.3 nm to 1 nm, inclusive.

Conformally coating the first plurality of metallic nanostructures with the spacer layer may comprise atomic layer deposition.

The metallic layer may have an average thickness of 10 nm.

In various embodiments, the ground plate may be disposed on a substrate. The substrate may be generally smooth. The substrate may comprise glass, metal, silicon, or plastic.

In various embodiments, the ground plate may be reflective. The ground plate or the metallic layer may comprise a metal. The metal may comprise a noble metal. The noble metal may comprise silver, gold, or aluminum. The ground plate may be optically thick.

In various embodiments, the spacer layer may comprise a low-loss dielectric. The low-loss dielectric may comprise aluminum oxide, titanium dioxide, or silicon dioxide. The low-loss dielectric may be configured to transmit more than 80% of incident light. The spacer layer may have an average thickness from 10 nm to 100 nm, inclusive. The average thickness of the spacer layer may be 50 nm.

In various embodiments, the first plurality of metallic nanostructures may comprise a material configured for localized surface plasmon resonance. The material may comprise silver, gold, or palladium.

In various embodiments, the first plurality of metallic nanostructures may have an average thickness of 12 nm.

In various embodiments, the gaps may be approximately 0.5 nm to 0.8 nm.

In various embodiments, the second metallic layer may have an average thickness of 5 nm.

In various embodiment, the material of the first plurality of metallic nanostructures may be different than the material of the second plurality of metallic nanostructures.

In various embodiments, the first plurality of metallic nanostructures may have an average morphology having a pre-determined effective optical constant and light-trapping band. The pre-determined effective optical constant may be configured such that the first plurality of metallic nanostructures is configured to absorb more than 90% of light having wavelengths in the range of 784 nm to 1030 nm, inclusive.

In another embodiment, a SERS substrate may comprise a nanoporous dielectric layer and a plurality of metallic nanostructures. The nanoporous dielectric layer may comprise a plurality of nanopores having sidewalls. The plurality of metallic nanostructures may be disposed on at least a portion of the sidewalls of the plurality of nanopores such that a portion of the dielectric layer is exposed in gaps formed between the nanostructures of the first plurality of metallic nanostructures.

The nanoporous dielectric layer may be an anodic aluminum oxide membrane.

The plurality of metallic nanostructures may comprise a noble metal. The noble metal may comprise silver, gold, or aluminum.

Each of the nanopores in the plurality of nanopores may have a diameter between 50 nm and 400 nm, inclusive.

The nanorporous dielectric layer may have a periodicity of between 10 nm and 700 nm, inclusive.

The SERS substrate may further comprise a hydrophobic coating. The hydrophobic coating may be polytetrafluoroethylene.

A SERS system may comprise a SERS substrate as disclosed herein. The SERS substrate may be configured for the detection of a drug or a virus. The SERS substrate may be configured as a flow-through sensor.

### BRIEF DESCRIPTION OF THE FIGURES

For a fuller understanding of the nature and objects of the disclosure, reference should be made to the following detailed description taken in conjunction with the accompanying drawings, in which:

FIG. 1 illustrates a perspective view of an embodiment structure for SERS;

FIG. 2 illustrates (a-c) Schematic of the device fabrication process. Direct deposition of metal followed by thermal annealing is used to pattern the first layer of random nanostructure on the glass substrate. These patterns are conformally encapsulated with a thin alumina spacer using atomic layer deposition (ALD). Next, an Au film is deposited conformally on the existing nanopattern, and the whole structure is stripped off the glass substrate using UV cured epoxy and a glass slide. (d-h) Top-view scanning electron microscope (SEM) images of different buried random nanopatterns. Red dotted squares: Further zoomed-in images show a 1 nm nanogap surrounding the existing nanopatterns. (i) Cross-sectional TEM of a 10-Å-wide Al₂O₃ layer between Ag and Au layers;

FIG. 3 illustrates (a) Microscopic reflection image of the random nanogap structure. (b) Microscopic mapping of random nanogap structure surface in the red solid square in (a) under the 20× objective lens. (c) Raman mapping of the same area shown in (b). (d) Large area fabrication of 1 nm nanogaps array. (e) Well placement and layout for uniformity study and (f) corresponding EF results for SERS measurements of BPE. The SERS spectra were taken at a laser excitation wavelength of 785 nm, and the EF was measured with the 1608 cm⁻¹ peak of BPE. (g) Different fabrication batches performance comparison under different objective lens. (h) Uniformity comparison with different commercial SERS substrates under different objective lens. (i) Raman mapping of different nanostructures;

FIG. 4 illustrates (a) Relationship between the Raman intensities at the peak of 1608 cm⁻¹ and different concentrations of BPE ethanolic solutions. (b) SERS spectra of BPE ethanolic solutions with different nanogap structures. (c) SERS spectra of 6-Benzylaminopurine ethanolic solutions with different concentrations on the nanogap structure with 1 nm gap. (d) Relationship between the Raman intensities at the peak of 1030 cm⁻¹ and different concentrations of BPE ethanolic solutions. (e-g) Raman spectra of (e) Clonazapam, (f) Phenolphthalein, and (g) Sudan I molecules in the nanogaps;

FIGS. 5A and 5B illustrate Metal coated Anodic Alumina Oxide (AAO) substrates has been reported for solar vapor generation. In the present disclosure, an AAO-based SERS substrate is provided with surprisingly high performance for SERS sensing. FIG. 5 shows an illustration of the nanochip fabrication and its SEM image;

FIG. 6 illustrates We revealed that its surface chemical property is changed with the metal coating. The original bare AAO substrate is hydrophilic. After the metal coating, two sides of the AAO sample become more hydrophobic. The metal coating side is the most hydrophobic. In this case, the different surface chemical properties will be unique to separate chemicals from aqueous solutions;

FIG. 7 illustrates When we put the water-based chemical sample on top of the chip, its sensing performance is superior, with the sensitivity of ˜1 nM, which is among the best reported results based on nanochips fabricated by expensive top-down lithography and observed under high performance Raman microscope (e.g., AIP Advances 7, 065205 (2017)). In the presently-disclosed structure, the cost is much lower than those nanochips and the performance is even better using inexpensive Raman spectroscopy (including portable Raman system). This chip is promising to overcome the cost barrier of SERS chip to get into the market;

FIG. 8 illustrates THC;

FIG. 9 illustrates Fentanyl Gold;

FIG. 10 illustrates a-c) Manufacturing procedure to fabricate three-layered absorbing metasurface with multistep deposition processes. d) A tilted cross-sectional SEM image of three-layered absorbing metasurface on silicon substrate. Scale bar: 200 nm. e) Absorption spectra of the three-layered absorber before (yellow curve) and after (red curve) the second-step deposition, and their corresponding reference structures with NPs only on glass substrates (green and purple curves);

FIG. 11 illustrates a,b) SEM images of top random Ag NPs (a) before and (b) after an extra 5 nm thick Au NP deposition. The scale bar is 500 nm. White dotted squares: areas loaded for simulation. c,d) Modeled electric field enhancement distribution among the NPs (at λ=785 nm) in the white dotted squares in (a) and (b) at the normal incidence. e) SERS spectra of BPE molecules on metasurface chips with and without the second-step deposition process;

FIG. 12 illustrates a,b) Raman maps of metasurfaces (a) without and (b) with the second-step deposition process within an area of 30 μm×30 μm. c) SERS spectra of BPE ethanolic solutions with different concentrations on the hybrid Ag—Au metasurface. d) Relationship between the Raman intensities at the peak of 1608 cm-1 and different concentrations of BPE ethanolic solutions. e) Direct comparison of Raman intensities over different periods obtained by previously reported structures and the metasurface (i.e., the red stars);

FIG. 13 illustrates a,b) SERS spectra of cocaine acetonitrile solutions with different concentrations on (a) the hybrid Ag—Au metasurface and (b) two commercial substrates. Inset in (a): chemical structures of cocaine molecule. c,d) SERS spectra of (c) 4-MBA and (d) R6G molecules on the hybrid Ag—Au metasurfaces and two commercial substrates. Insets: chemical structures of (c) 4-MBA and (d) R6G molecules;

FIG. 14 illustrates a) Absorption spectra of three metasurfaces: i.e., single-Ag (yellow curve), Ag—Ag (blue curve), and Ag—Au (red curve) metasurface chips. Black dashed line corresponds to the excitation wavelength of 785 nm. b) SEM images of top random Ag NPs before and after an extra 5 nm thick Ag or Au NP deposition. The scale bar is 100 nm. c) SERS spectra of BZT molecules on the metasurfaces with and without the second-step deposition. Inset: the chemical structure of BZT molecules. d) Schematic illustration of BZT molecular self-assemblies on the metasurfaces without (middle) and with the second-step Ag (left) or Au (right) NPs;

FIG. 15 illustrates Relationships between Raman intensities at different signature peaks and different concentrations of BPE ethanolic solutions;

FIG. 16 illustrates Absorption spectra of the hybrid Ag—Au metasurface at various storage time;

FIG. 17 illustrates Modeled electric field enhancement distribution among NPs (at λ=785 nm) of (a) Ag—Ag and (b) Ag—Au metasurface chips at the normal incidence;

FIG. 18 illustrates an embodiment method according to embodiments of the present disclosure; and

FIG. 19 illustrates an embodiment method according to embodiments of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

Embodiments disclosed herein include structures for Surface-Enhanced Raman Spectroscopy (SERS), methods for making the same, and SERS systems comprising the same.

The present disclosure may be embodied as a random nanogap structure, which may be based on atomic layer deposition (ALD) fabrication technology. By shrinking the nanogap size towards the quantum regime (i.e., ˜1 nm), nonlocality of the optical field may be achieved: i.e., the optical field may be confined within the nanogap uniformly no matter the shape of the metallic nanopattern, even in random metal patterns. A random structure may perform much better than traditional periodic array nanostructures-setting a new record of uniformity with the relative standard deviations (RSD) of 1.9%. This efficient light-trapping nanostructure may be completely lithography free, suitable for large-area manufacturing, including roll-to-roll processes. It may enable the development of low-cost, high-performance SERS chips for emerging portable Raman spectroscopy systems.

Metallic nanostructures with nanometer gaps may support hybrid plasmonic modes that can confine the electromagnetic field into subwavelength volume with strong localized field intensity. It may provide an attractive plasmonic platform for exploring novel light-matter interaction phenomena at the nanoscale. Such significant field localization may result in strong light absorption and scattering enhancement of plasmonic nanostructures and produce an intense electric field for boosting various optical effects, such as SERS, surface-enhanced infrared absorption spectroscopy (SEIRA), and nonlinear processes.

Various metallic nanogap structures have been fabricated based on physical (e.g., electron-beam lithography (EBL), focused-ion beam (FIB), nanoimprint) and chemical (e.g., nanoparticle self-assembly, core-shell nanoparticle assembly, particle-on-film nanocavity) methods. However, the nanofabrication methods for sub-2-nm nanogaps still face challenges in achieving a controllable gap size, accurate dimensions, scalable fabrication, and reproducible features. Recently, a sandwich-structured nanogap was obtained by inserting an ultrathin layer between two metal nanopatterns using an ALD method. The advantage of this method is that it can provide controllable ultrathin layer thickness in large areas. This ultrathin layer can also be removed easily to form an air gap for real applications.

Taking advantage of this feature of ultrathin film deposition, the ultra-small nanosize dimension, which is independent of lithography control, has been successfully obtained. However, previous techniques still rely on conventional optical lithography methods to define the initial metal pattern. Such optical lithography methods are expensive and complicated. Moreover, nonlocal electromagnetic effects have been revealed when the nanogap size becomes close to the quantum regime. In this case, the hot spots induced by the localized electromagnetic field may be not only distributed at the corner, edge, or between interparticles, but also fill in the full nanogaps vertically and horizontally. Then, the gap's size and density may dominate the field distribution for the sub-nanometer structures instead of the initial nanopattern morphology. This feature is especially beneficial to improve the uniformity for quantitative sensing.

Embodiments herein may comprise a random nanogap structure. The structure may be achieved using, for example, ALD fabrication technology. By shrinking the nanogap size to less than 2 nm, a stronger localized field may be induced due to optically-driven free electrons coupled across the gap, and, therefore, boosts the SERS sensing performance.

Using direct deposition, with or without post-thermal annealing processes, random nanoparticles (NPs) can be created to couple the incident light and realize the localized hot spot at the edges of the discrete NPs. Due to the unpredictable randomness of the surface NPs morphology, different NPs can function as different optical antennas to excite hot spots at edges and gaps between the NPs at different wavelengths. However, the discrete randomness of metallic nanopatterns also results in randomness of the field localization. In addition, the large interparticle nanogap sizes may also suppress the efficient coupling of incident light. Among the numerous nanostructures, metallic nanogap structures may be significant because they enable high electromagnetic field confinement and enhancement at the subwavelength scale. The localized field enhancement may increase monotonically by four orders of magnitude when the gap size decreases from 10 to 1 nm. In particular, as the gap size decreases toward the subnanometer scale, quantum mechanical effects, including nonlocal electromagnetic effects and electron tunneling, become very important and begin to influence the optical response. The electromagnetic fields can be squeezed into a small volume when the gap size decreases to 1 nm, leading to near nonlocal field localization with higher electric field enhancement. Even though the initial main nanopatterns are random nanostructures, the field localization becomes more nonlocally uniform as the gap size decreases to subnanometer, which means the gaps size and density will dominate the field distribution for the subnanometer structures. However, the experimental study of nonlocality on coupled plasmonic systems has been hindered by the difficulty in achieving reliable and precise control of subnanometer interparticle spacing. Even a relatively simple system, such as two nanospheres separated by a subnanometer gap, remains a challenge for colloidal or lithographic synthesis methods. Embodiments herein solve this problem with a simple method to fabricate a random nanogap structure and provide precise control of nanogap sizes.

In another aspect, embodiments combine a nanoporous layer, such as, for example, anodic alumina oxide (AAO), with random metallic nanoparticles. By depositing metal films on AAO substrates, random metallic nanostructures can be formed on the wall of nanopores, resulting in an excellent light trapping and field localization features. According to preliminary tests, the performance of this chip is superior over many commercial chips and can sense BPE molecules at the low concentration of 10 nM using a low-cost portable Raman spectroscopy system (BWK).

In another aspect, an embodiment is a method to manufacture scalable broad-band super absorbing metasurface substrates for SERS. In some embodiments, deposition and subsequent thermal annealing may shrink the gap among metallic nanoparticles with no top-down lithography technology involved. In some embodiments, a hybrid Ag—Au metasurface structure enables a light-trapping strategy to localize excitation laser energy at the edges of the nanostructures more efficiently, resulting in enhanced sensing resolution. Since more hot spots may be excited over a given area with higher density of small nanoparticles, the spatial distribution of the localized field may be more uniform, resulting in superior performance for potential quantitative sensing of drugs and chemicals. Therefore, embodiments may manufacturing and specialty barrier for scalable uniform SERS substrates with high enhancement factors.

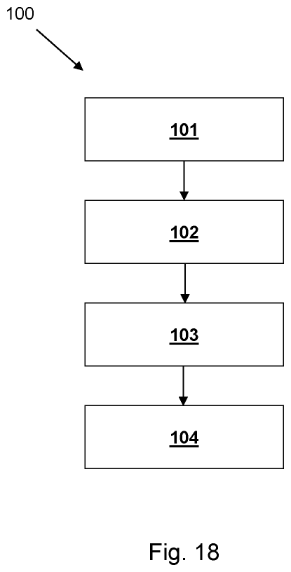

In an embodiment, as depicted in FIG. 18, a method 100 for manufacturing a substrate for Surface-Enhanced Raman Spectroscopy (SERS) may comprise, at 101, providing a ground plate.

At 102, a spacer layer may be provided on the ground plate.

At 103, a first plurality of metallic nanostructures may be formed on the spacer layer such that a portion of the spacer layer is exposed in gaps formed between the nanostructures of the first plurality of metallic nanostructures.

At 104, a second plurality of metallic nanostructures may be formed on the spacer layer in the gaps of the first plurality of metallic nanostructures.

The gaps between the nanostructures of the first plurality of metallic nanostructures may describe the space between each of the metallic nanostructure. For instance, a gap may describe space between one metallic nanostructure and an adjacent metallic nanostructure. In this way, an average gap size for a plurality of metallic nanostructures may describe the average distance between a given metallic nanostructure in a plurality of metallic nanostructures from metallic nanostructures adjacent to it. Thus, the second plurality of metallic nanostructures may fill these gaps between the first metallic nanostructures and this be isolated from each other. In some embodiments, the nanostructures of the second plurality of metallic nanostructures are isolated from each other.

In some embodiments, forming the first plurality of metallic nanostructures on the spacer layer includes depositing a first metallic layer on the spacer layer and annealing the first metallic layer. Such a first metallic layer may be deposited at a thickness of, for example, 12 nm-15 nm, inclusive, although the thickness may be greater than or less than these exemplary values depending on parameters such as, for example, the material used. The first metallic layer may be annealed at a temperature such that the first metallic layer is transformed into the first plurality of metallic nanostructures disposed and exposing a portion of the spacer layer in gaps formed between neighboring nanostructures. The first metallic layer may be made from any material supportive of localized surface plasmon resonance. For example, the first metallic layer may be a noble metal such as, for example, gold, silver, palladium, etc. In a particular example, the first metallic layer is silver, and the annealing temperature may be 200° C.

In some embodiments, the first plurality of metallic nanostructures is formed on the spacer layer by depositing a thin (e.g., 5 nm to 8 nm, inclusive) first metallic layer on the spacer layer. In this way, no annealing is required because the thin first metallic layer will self-assemble into the first plurality of metallic nanostructures.

In some embodiments, forming the second plurality of metallic nanostructures includes depositing a second metallic layer on the first plurality of metallic nanostructures and the exposed portion of the spacer layer. The second metallic layer may be annealed at a temperature such that the second metallic layer is transformed into the second plurality of metallic nanostructures disposed in the gaps of the first plurality of nanostructures. The second metallic layer may be made from any material supportive of localized surface plasmon resonance. For example, the second metallic layer may be a noble metal such as, for example, gold, silver, palladium, etc. The second metallic layer may be made from the same material as the first metallic layer or a different material. In a particular example, the second metallic layer may comprise gold and the annealing temperature may be 150° C.

In various embodiments, the second metallic layer may have an average thickness of 5 nm-8 nm, inclusive, although the thickness may be greater than or less than these exemplary values depending on parameters such as, for example, the material used.

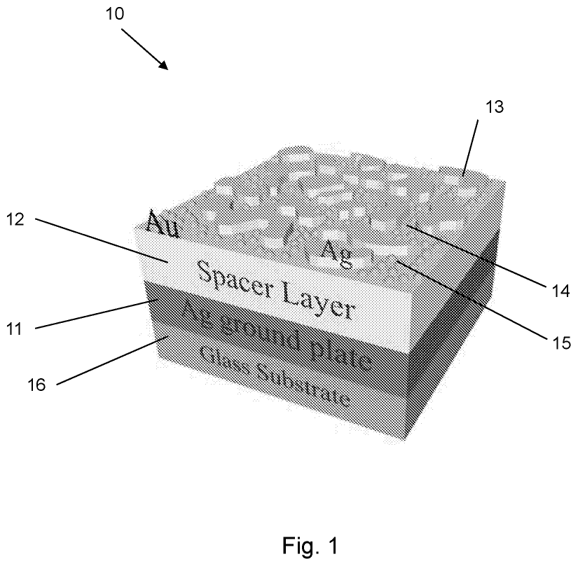

In another embodiment, as depicted in FIG. 1, a structure 10 for Surface-Enhanced Raman Spectroscopy (SERS) may comprise a ground plate 11, a spacer layer 12 disposed on the ground plate 11, a first plurality of metallic nanostructures 13 disposed on the spacer layer 12 such that a portion of the spacer layer 12 is exposed in gaps 14 formed between the nanostructures of the first plurality of metallic nanostructures 13, and a second plurality of metallic nanostructures 15 disposed on the spacer layer 12 in the gaps 14 of the first plurality of metallic nanostructures 13.

In various embodiments, the ground plate 11 may be disposed on a substrate 16. The substrate 16 may be generally smooth. The substrate 16 may comprise glass, metal, silicon, or plastic. In various embodiments, the ground plate 11 may be reflective. The ground plate 11 may be considered reflective when its properties are such that a significant portion (e.g., 10% to 100%) of light incident on the ground plate 11 is reflected. In some embodiments, the ground plate 11 may be considered reflective where substantially all of the light incident on it is reflected.

The ground plate 11 may comprise a metal, such as, for example, a noble metal, silver, gold, or aluminum. The ground plate may be optically thick. For Aluminum, the ground plate may be at least, for example, 150 nm thick.

The spacer layer 12 may be a dielectric material such as, for example, aluminum oxide, titanium dioxide, or silicon dioxide. Such a dielectric material may be a low-loss material (e.g., able to transmit more than 80% of incident light through the material. In various embodiments, the spacer layer 12 may comprise a low-loss dielectric. The low-loss dielectric may comprise aluminum oxide, titanium dioxide, or silicon dioxide. The low-loss dielectric may have a transmission coefficient greater than 0.9. The spacer layer 12 may have an average thickness from 10 nm to 100 nm, inclusive. The average thickness of the spacer layer 12 may be 50 nm.

In various embodiments, the first plurality of metallic nanostructures 13 may comprise a material configured for localized surface plasmon resonance (SPR). SPR is induced by collective oscillation of electrons which can lead to high electromagnetic field enhancement in nanomaterials and nanostructures such as the first plurality of metallic nanostructures 13. The material that comprises the first plurality of metallic nanostructures 13 may comprise silver, gold, or palladium.

In various embodiments, the first plurality of metallic nanostructures 13 may have an average thickness of 12 nm.

In various embodiments, the gaps 14 may be approximately 0.5 nm to 0.8 nm.

In various embodiment, the material of the first plurality of metallic nanostructures 13 may be different than the material of the second plurality of metallic nanostructures 15.

In various embodiments, the first plurality of metallic nanostructures 13 may have an average morphology having a pre-determined effective optical constant and light-trapping band. The pre-determined effective optical constant may be configured such that the first plurality of metallic nanostructures 13 is configured to absorb more than 90% of light having wavelengths in the range of 784 nm to 1030 nm, inclusive.

In another embodiment, a SERS system may comprise any of the presently-disclosed SERS structures, such as the SERS structure 10 depicted in FIG. 1. Such a SERS system may be configured for the detection of a drug or a virus.

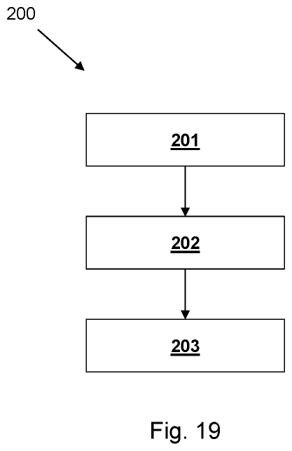

In another embodiment, as depicted in FIG. 19, a method 200 for manufacturing a SERS nanostructure may comprise, at 201, forming a first plurality of metallic nanostructures on a substrate such that a portion of the substrate is exposed in gaps formed between the nanostructures of the first plurality of metallic nanostructures.

At 202, the first plurality of metallic nanostructures may be conformally coated with a spacer layer.

At 203, a metallic layer may be deposited on the spacer layer.

Forming the first plurality of metallic nanostructures may comprise depositing a metal on the substrate. The deposited metal may be annealed at a temperature to form the first plurality of metallic nanostructures. The metal may be deposited to an average thickness from 10 nm to 15 nm, inclusive. Depositing the metal on the substrate may be performed using, for example, electron-beam evaporation. The annealing temperature may be, for example, 300° C. (or as selected from any temperature where the deposited metal will form into a plurality of metallic nanostructures with the desired gap size between structures).

The method may further comprise template stripping the SERS nanostructure from the substrate. Template stripping the SERS nanostructure from the substrate may comprise applying a UV-curable optical adhesive to the metallic layer. The UV-curable optical adhesive may be covered with a glass slide. The UV-curable optical adhesive may be cured. The SERS nanostructure may be removed from the substrate.

In some embodiments, the spacer layer may have an average thickness less than 2 nm. For example, the average thickness of the spacer layer may be from 0.3 nm to 1 nm, inclusive.

Conformally coating the first plurality of metallic nanostructures with the spacer layer may comprise atomic layer deposition.

The metallic layer may have an average thickness of 10 nm.

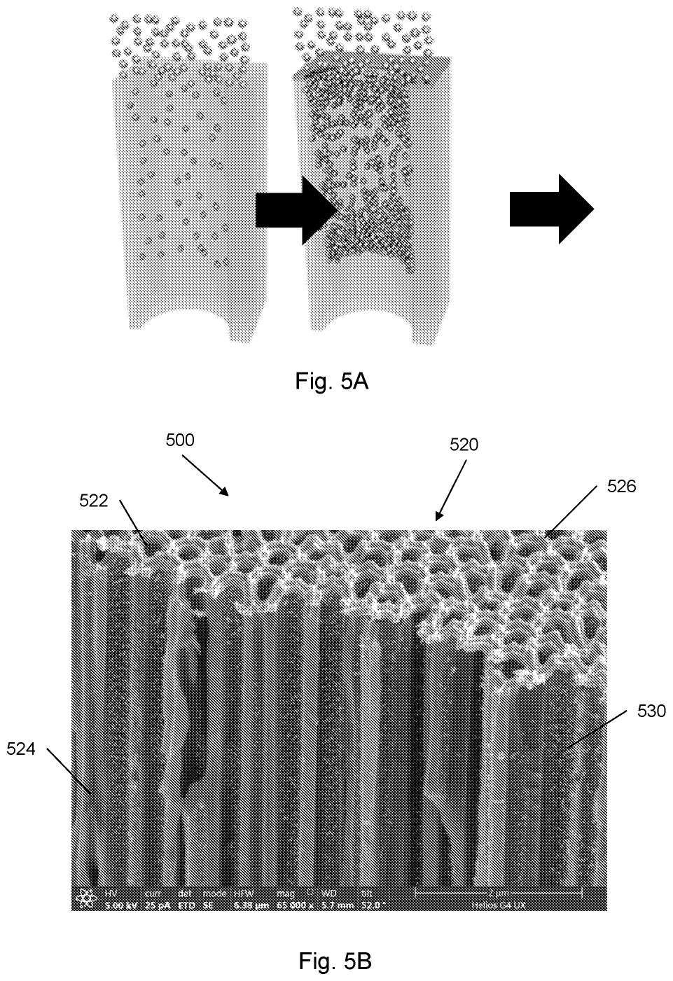

In another aspect, the present disclosure may be embodied as a SERS substrate 500 (see, e.g., FIG. 5B). Such a SERS-active substrate may be suitable for use with devices such as, for example, Raman Analyzers, Raman Spectrometers, etc. The SERS substrate includes a nanoporous dielectric layer comprising a plurality of nanopores having sidewalls. In some embodiments, the nanoporous dielectric layer is an anodic aluminum oxide (AAO) membrane, sometimes referred to as anodic alumina. Suitable nanoporous dielectric materials have structures organized into numerous parallel pores that may extend through a thickness of the layer. FIG. 5B shows an example of an AAO membrane 520 having a plurality of nanopores 522, each having a sidewall 524.

Embodiments of the present SERS substrate include a plurality of metallic nanostructures 530 disposed on a least a portion of the sidewalls 524 of the plurality of nanopores. As described above, the metallic nanostructures are made from a material (or materials) which supports localized surface plasmon resonance. For example, the metallic nanostructures may be made from a noble metal, such as, for example, gold, silver, palladium, etc. Other suitable materials supportive of localized surface plasmon resonance are known to those having skill in the art. The plurality of metallic structures 530 are configured such that a portion of the dielectric layer is exposed in gaps formed between the nanostructures of the plurality of metallic nanostructures. Such gaps may have a width ranging from 20 nm (or less)-100 nm (or more), inclusive. In some examples, gap sizes of 0.5 nm-0.8 nm to 10 nm or more were achieved. In some embodiments, the metallic nanostructures may also form on a surface 526 of the membrane.

In a particular example, gold nanoparticles were deposited on an AAO membrane using, for example, physical vapor deposition (PVD). Using PVD, the gold nanoparticles could be deposited deep into the nanopores. In a test embodiment, 80 nm gold nanoparticles were deposited on a 40 μm thick AAO membrane. The gold nanoparticles were able to penetrate more than 10 μm into the membrane. In this way, the metallic nanostructures coat a portion of the sidewalls of the nanopores.

The nanoporous membrane may have characteristics suited for the particular application at hand. For example, the nanoporous membrane may have nanopores with diameters ranging from 30 nm-400 nm, inclusive (note that diameters may be smaller or larger than this exemplary range). The nanopores may be formed in the membrane with a periodicity ranging from 10 nm-700 nm. The nanoporous membrane may have a thickness in the range of from 2 μm (or less) to several hundred microns.

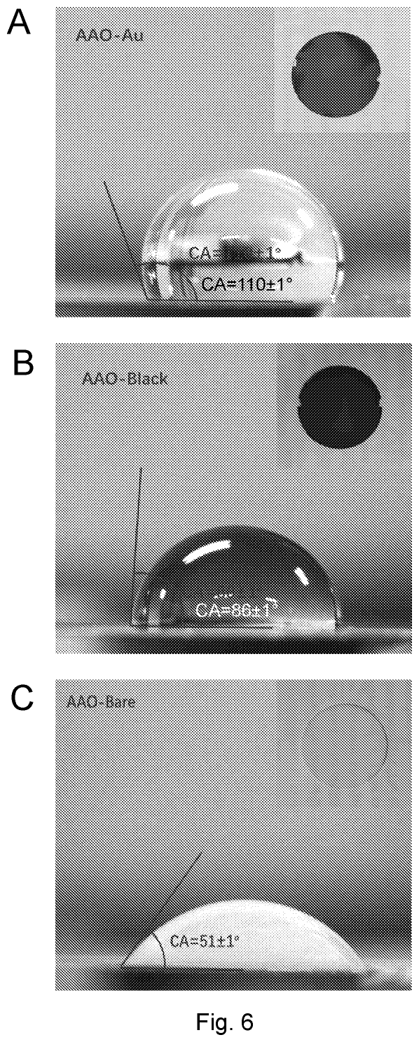

Embodiments of the present SERS substrate have been shown to more hydrophobic than uncoated AAO. For example, FIG. 6 (top) shows a water droplet disposed on a test substrate made from AAO with gold nanostructures, where the water droplet is placed on the side of the substrate from which the gold was deposited. The critical angle (CA) of 110±1° is significantly greater than that of a droplet on an uncoated AAO structure (CA=51±1°) shown in FIG. 6 (bottom). FIG. 6 (middle) shows a droplet placed on the opposite side of the gold deposition and having a hydrophobicity with CA=86±1°. In some embodiments, the SERS substrate may be further treated with a hydrophobic coating. For example, the SERS substrate may have a polytetrafluoroethylene (PTFE) coating. The increased hydrophobicity of the SERS substrate can be advantageous in allowing a water-based sample to spread over a smaller area of the substrate than would with a less hydrophobic substrate. This results in a higher concentration of the sample once the water is allowed to evaporate from the sample. As mentioned above, embodiments of the SERS substrate 500 may be suitable for use in, for example, Raman spectroscopes. In a method for preparing a sample for SERS, a SERS substrate according to any of the embodiments described herein is provided. A sample is disposed on the SERS substrate and allowed to dry.

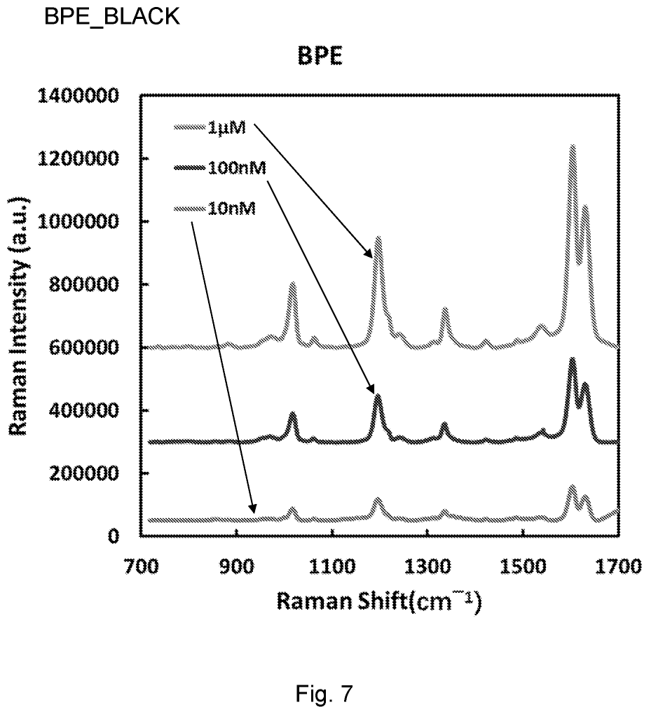

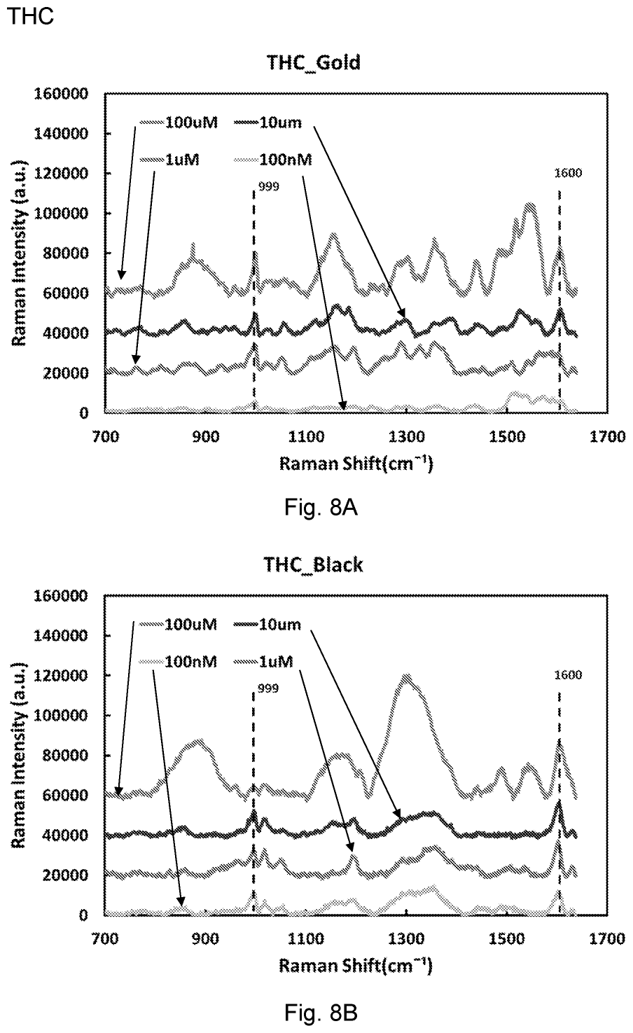

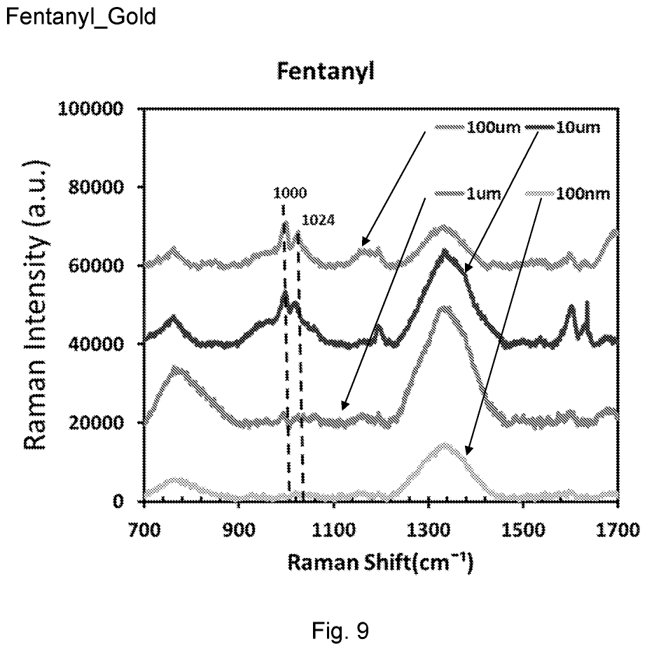

In some embodiments, a SERS system may be configured such that a sample substance is flowed through an embodiment of the present SERS substrate. For example, a gas sample may flow from one side of the SERS substrate, through a plurality of the nanopores to the opposite side of the substrate. Such an embodiment may advantageously be used to filter only particles of the size of the substance-of-interest. In a particular example, currently a coronavirus is impacting society at large, and there are few ways to easily detect the virus. Some research has shown that the COVID-19 virus particle has a diameter of approximately 125 nm. As such, a SERS system configured to detect the virus may advantageously use a SERS substrate based on a nanoporous dielectric layer having nanopores sized to permit passage of the virus particles and filter out larger particles. In this way, a gas sample may be passed through the SERS substrate, and the device may provide an alert if virus particles are detected in the gas sample. Such a device can be used for testing specific gas samples and/or for general monitoring of an environment (e.g., continuously until virus particles are detected). The COVID-19 example is intended to be non-limiting, and embodiments of the SERS substrate may be configured to detected larger or smaller particles (e.g., viruses, drugs, etc.) in flow-through or non-flow-through configurations. FIGS. 7, 8, and 9 show sensitivity results from detecting various drugs (1,2-bis(4-pyridyl)-ethylene (BPE), Tetrahydrocannabinol (THC), and Fentanyl, respectively) in samples using test embodiments of the present disclosure.

### Example 1

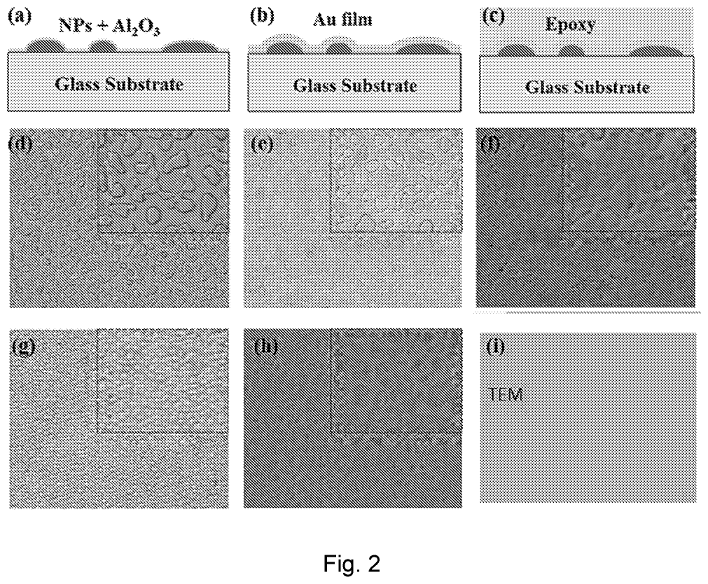

As illustrated for example in FIG. 2, an embodiment of the disclosed random nanogap structure may be constructed by burying dielectric-coated metal random nanopatterns into another metal film. As a result, the intense nanocavity introduced by the ultra-thin insulating film can help efficiently couple the incident light. The insulating film can be removed without compromising the mechanical stability of the cavity and backfilled with analyte molecules for enhanced sensing. Plasmonic hotspots may be generated along the intense nanocavity rings, and thus, the improved uniformity of hotspots is beneficial to quantitative sensing. Importantly, these cavities may be protected by a glass slide and can be exposed via template stripping immediately before use, preventing surface contamination.

An example process flow for making an embodiment random nanogap structure is illustrated in FIGS. 2(a-c). First, a 12 nm thick silver (Ag) thin film may be deposited onto a pre-cleaned glass substrate using electron-beam evaporation. Thermal annealing may be used to manipulate the average morphology (e.g., size, spacing) of the first layer of Ag NPs to form the first layer of nanopatterns. It should be noted that in some embodiments, no adhesion layer is used between the Ag film and the glass substrate, while an adhesion layer is used for template stripping of the final SERS nanostructure. The first layer of Ag nanopatterns may then be conformally coated with a thin layer of 1 nm alumina (Al₂O₃) using atomic layer deposition (ALD) (FIG. 2(a)). A second layer of metal (10 nm thick Au) may then be deposited on top of the alumina to form the nanogap between the Au films and Ag nanopatterns, with the gap width precisely defined by the thickness of the ALD-grown Al₂O₃ film (FIG. 2(b)). Finally, the nanogap structures may be template-stripped and exposed for molecule deposition and spectroscopic measurements. For this template stripping step, a UV-curable optical adhesive may be applied to the surface of the Au film (FIG. 2(c)), covered with a glass slide, and cured under a UV lamp, and the whole structure may be stripped off the glass substrate finally. As the adhesive is in contact only with the second metal layer, the process may not leave any residue on the sample. Although the overall footprint of the nanopatterns is random, the gap size may be independently controlled by ALD, giving uniform Ångstrom-scale lateral resolution along the entire contour of structures in large area. FIG. 2(d-h) depicts the scanning electron microscope (SEM) images of example 1-nm thick annular gaps formed between different random metal nanopatterns and second metal layers. As shown in FIG. 2(d-f), the initial thicknesses of first Ag metal layers may be 12 nm, 10 nm, and 15 nm, followed by thermal annealing of 300° C. to form different nanopattern templates. If the metal thickness is far below a percolation threshold (e.g., 5 nm Ag film in FIG. 2(g)), the initial surface morphology may be in the form of small isolated NPs. The metal of initial nanopatterns can also be changed from Ag to Au. As shown in FIG. 2(h), an 8 nm thick Au thin film may be deposited onto a pre-cleaned glass substrate followed by thermal annealing of 400° C. As shown in FIG. 2(i), transmission electron microscopy (TEM) may be used to verify the thickness of a 10-Å-thick Al₂O₃ layer on the sidewall of a cross-sectional Ag/Al₂O₃/Au nanogap.

### Example 2

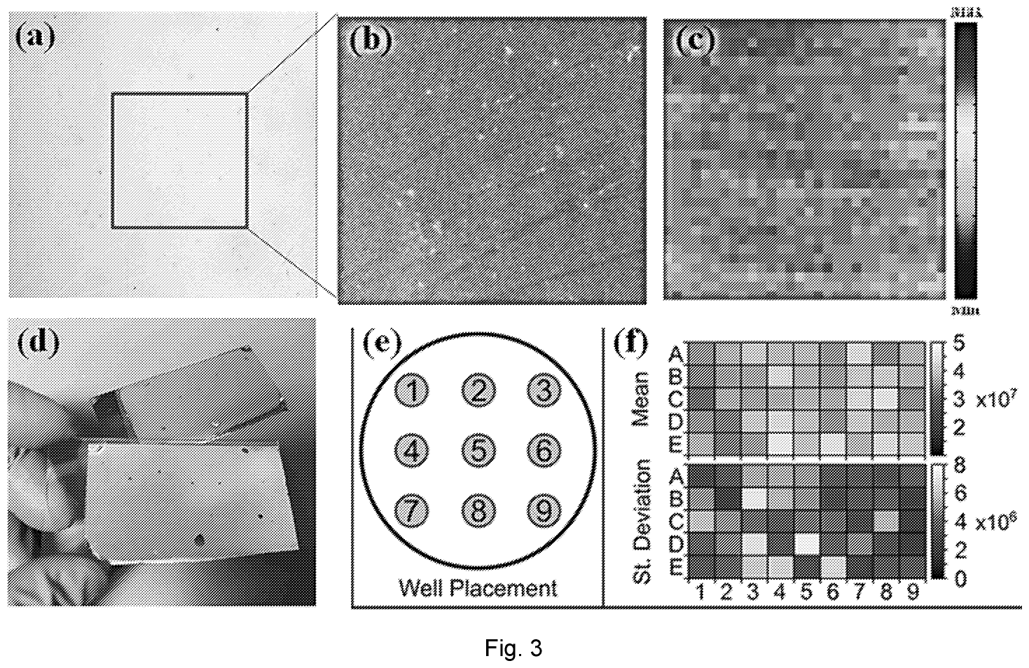

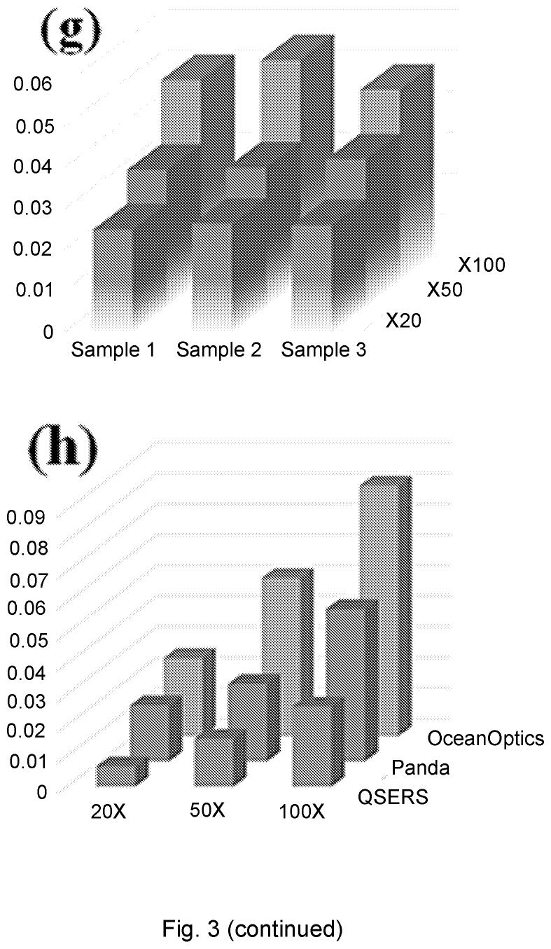

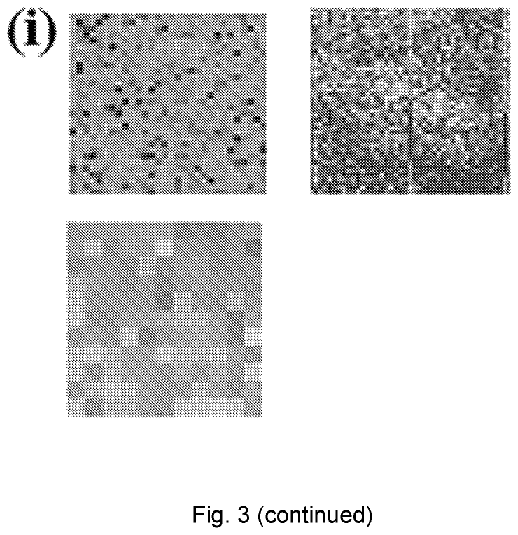

The near nonlocal field localization with higher electric field enhancement may be realized in the simulation. In this case, these hot spots supported by the ultra-small nanogaps distribute more uniformly compared with random nanopatterns. Therefore, this random nanogap structure is promising to result in better spatial uniformity. As shown in FIG. 3(a), the random nanogap structure was first illuminated by a white light source and its reflection image was observed through the ×20 objective lens and captured by a CCD camera (Hamamatsu). An area of 30 μm×30 μm was selected in the image and analyzed to get the surface variation with the relative standard deviations (RSD) of 1.9% (FIG. 3(b)). Next 1,2-bis(4-pyridyl)-ethylene (BPE) was selected as the sensing molecule. The random nanogap structure was immersed in 1 mM BPE ethanolic solutions for 10 min and then air-dried. Then it was rinsed with pure ethanol. The SERS signals were characterized using a bench-top Renishaw inVia Raman microscope equipped with a 785 nm laser. In this experiment, a two-dimensional Raman mapping at the peak of 1608 cm-1 was performed over the same area in FIG. 3(b) with a step size of 1 μm. As shown in FIG. 3(c), the RSD of Raman intensities is 2.5%, slightly higher than the surface variation of 1.9%. The variation difference can be attributed to the molecule distribution on the surface of random nanogap structure. It should be noted that this uniformity is especially high and almost better than all SERS substrates fabricated by different methods. Due to the advantage of avoiding the lithography method, the random nanogap structure could be produced over a large area to realize the high throughput production. FIG. 2(d) exhibits the nanogaps fabricated over the entire glass wafer (50 cm×80 cm), on which the 1 nm nanogaps are formed along the contour of first random NPs pattern. Despite of the shape and contour profile of nanopatterns, the density of the nanogaps arrays is dependent on the density of the initial nanopatterns. The yield of the plug-and-peel process for this wafer-scale metal/Al₂O₃/metal random nanogap structure is over 95%. As shown in FIG. 2(e), nine areas with the same sizes were randomly selected to analyze the overall uniformity in large area. For each area of 30 μm×30 μm, 900 points were analyzed. The average RSD of Raman intensities in these 10 points is 3%, as shown in FIG. 2(f). We also fabricated three different batches of substrates, as shown in FIG. 2(g). The Raman mappings were performed under ×20, ×50, and ×100 objective lenses, respectively. The variation of different batches is small, while the uniformity becomes worse when objective lens changes from ×20, ×50 to ×100. This can be attributed to the size change of laser focal area. When the objective lens changes from ×20 to ×100, the laser spot size becomes smaller, which will amplify the variation fluctuation since each spot size is composed of many different random nanopatterns. However, the uniformity is still higher than three commercial SERS substrates (i.e., Panda, QSERS, OceanOptics) (FIG. 3(h)) and four proposed SERS substrates (FIG. 3(i)). Therefore, it is promising to enable affordable quantitative analysis.

### Example 3

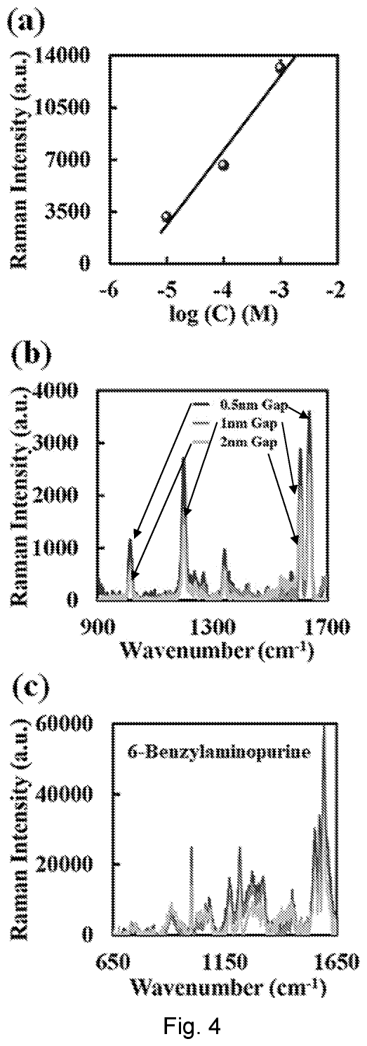

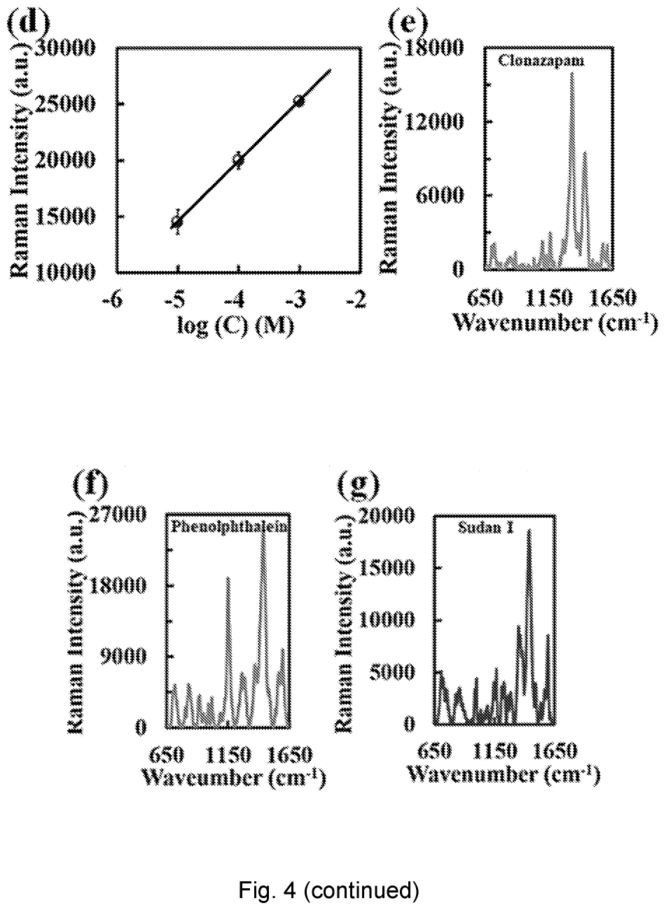

Realization of high resolution quantitative sensing via cost-effective chips and portable Raman spectrometers is one of the great challenges for SERS sensing. To quantitatively evaluate our random nanogap structure SERS chips, we placed 10 μL BPE ethanolic solutions onto the metasurface chips with the concentrations from 1 mm to 10 μm, then air-dried these chips. As such, it exhibits the SERS spectra of BPE solutions with different concentrations. The signature Raman peaks of BPE were observable at concentrations as low as 10 μM. By extracting the signal peak intensities at the specific Raman peak at 1608 cm⁻¹, one can reveal its linear relationship with the concentration of BPE ethanolic solution. As shown by the data fitting of the signal intensity at a selected peak at 1608 cm⁻¹ in FIG. 4(a), a linear correlation coefficient of 0.942 was achieved, suggesting its potential for quantitative SERS analysis.

### Example 4

It is generally believed that smaller gaps between metallic nanopatterns will result in stronger localized field due to optically driven free electrons coupled across the gap. In recent years, significant effort has been invested to reveal the upper limit for plasmonic enhancement using ultra-small gaps, even approaching the quantum limit within subnanometer regions. In the presently-disclosed fabrication method, the nanogap size can be controlled accurately by just changing the alumina thickness. We then fabricated three random nanogap structures with different nanogap sizes ranging from 0.2 nm to 2 nm under identical experiment conditions. As shown in FIG. 4(b), it was confirmed that the Raman signal from the 0.5 nm nanogap structure was the strongest. Next this substrate will be used for afterwards sensing applications.

### Example 5

To demonstrate the practical application of the proposed random nanogap structure SERS chip, we first selected 6-Benzylaminopurine as the sensing target. 6-Benzylaminopurine is a first-generation synthetic cytokinin that elicits plant growth and development, which will increase post-harvest life of green vegetables. However, the use of this cytokinin has been progressively increasing over the past years, and this has attracted intense public concern worldwide about trace amounts of the residues in agricultural products that might cause long-term nonfatal health effects. Therefore, there is a great need to develop a sensitive, reliable and fast sensing technology. In order to evaluate the limit of detection of the random nanogap structure for chemical residue analysis, a series of low-concentration 6-Benzylaminopurine solutions were tested. In the experiment, we placed 10 μL 6-Benzylaminopurine ethanolic solutions onto the chips with the concentrations from 1 mm to 10 μm, then air-dried these chips. As shown in FIG. 4(c), the vibrational modes of the cocaine molecules can be identified from the Raman spectra: The signature Raman peaks of 6-Benzylaminopurine are observable at concentrations as low as 10 μm. By extracting the signal peak intensities at the specific Raman peak at 1050 cm⁻¹, one can reveal its linear relationship with the concentration of 6-Benzylaminopurine ethanolic solution. As shown by the data fitting of the signal intensity at a selected peak at 1050 cm⁻¹ in FIG. 4(d), a linear correlation coefficient of 0.995 is achieved, suggesting its potential for quantitative SERS analysis in real applications. In addition, another three chemical molecules (i.e., Clonazapam, Phenolphthalein, Sudan I) related to food safety were also tested on these chips. As shown in FIGS. 4(e), 4(f) and 4(g), the vibrational modes of Raman signature peaks were observed clearly on our random nanogap structure chips. These experiments clearly demonstrated the improved sensing performance of the proposed random nanogap structure with smaller nanogaps.

Additional description is provided below with reference to particular illustrative embodiments, which are not intended to be limiting.

Reliability, shelf-time and uniformity are major challenges for most metallic nanostructures for SERS. Due to the randomness of localized field supported by silver and gold nanopatterns in conventional structures, it is a challenge for SERS sensing in quantitative analysis of sensing targets in practical applications, although it is one of the most sensitive optical sensing technologies. We propose a super absorbing metasurface with hybrid Ag—Au nanoantennas. A two-step deposition and thermal annealing process may shrink the gap among metallic nanoantennas with no top-down lithography technology involved. Because of the light trapping strategy enabled by the hybrid Au—Au metasurface structure, the excitation laser energy can be localized at the edges of the nanoantennas more efficiently, resulting in enhanced sensing resolution. Since more hot spots are excited over a given area with more smaller nanoantennas, the spatial distribution of the localized field may be more uniform, resulting in a superior performance for potential quantitative sensing of drugs (i.e., cocaine) and chemicals (i.e., molecules with thiol groups in this report). Furthermore, the final coating of the second Au nanoantenna layer improved the reliability of the chip, which has been demonstrated effective after 12-month shelf-time in regular storage environment. The superior feature may enable more affordable quantitative sensing using SERS technology.

SERS refers to a powerful vibrational spectroscopic technique capable of enhancing the weak and inelastic Raman scattering of low concentration analytes bound to or near patterned metallic surfaces. Utilizing this sensitive sensing technology, glucose, oligonucleotides, explosives, and other analytes of interest have been detected. In recent years, the unprecedented ability of nanoplasmonic/metamaterial structures to concentrate light has attracted significant research interests. It has been reported that the optical field can be concentrated into deep-subwavelength volumes and realize significant localized-field enhancement (so called hot spot) using a variety of nanoantenna structures (e.g., nanoparticle/sphere array, bow-tie nano-antennas, nano-rods, etc.). However, due to the diffraction limit of conventional optics, the light coupling efficiency from free-space into deep-subwavelength volumes is usually very weak. Furthermore, current dominant fabrication techniques are expensive and complicated to fabricate high quality SERS substrates over large areas, thus resulting in high prices for commercial SERS substrates. To overcome these limitations, recently we developed a simple, low-cost, scalable, and lithography-free method to manufacture three-layered metal-dielectric-metal (MDM) metamaterial super absorbers for SERS sensing. Using direct deposition and post-thermal annealing processes, super-absorbing plasmonic metamaterial structures were realized with very broad light trapping bands (i.e., >80% absorption band from 414 nm to 956 nm). In particular, the incident light can be efficiently coupled into the three-layered structure and localized at edges of nanoantennas, enabling the surface enhanced light-matter interaction for SERS.

In general, gold (Au) and silver (Ag) are most popular materials for SERS substrates. Au nanoparticles (NPs) are stable and biocompatible with various biomolecules like antigen, antibody, DNA, etc. Usually, Ag nanostructures exhibit better performance in SERS due to the stronger localized field. However, because of the surface oxidization, Ag nanostructures are less stable with shorter operational lifetime (i.e., shelf-time). Therefore, most commercial SERS products are based on Au nanostructures (e.g., gold nanopillars and gold nanopatterns). Recently, Au@Ag core-shell NPs and Au/Ag alloy nanocomposites were proposed to realize better performance in SERS applications with improved stability. In this work, we report a three-layered metamaterial super absorber structure with hybrid random Au and Ag NPs as the top nanoantenna. By immobilizing smaller Au NPs between larger Ag NPs, the gap between metallic NPs can be reduced significantly. Smaller gaps may result in stronger localized field due to optically driven free electrons coupled across the gap, and, therefore, boost the SERS sensing performance. In addition, due to the better stability of Au NPs and larger density of molecules on Au surfaces, the proposed hybrid Ag—Au metasurface may enable better sensing of biomolecules. Since no top-down lithography procedures were involved in the fabrication (e.g., electron beam lithography, nanoimprint, focused-ion-beam and self-assembled nanosphere methods), the proposed hybrid Ag—Au super absorber metasurface may realize a high performance, broadband and inexpensive sensing chip for SERS applications.

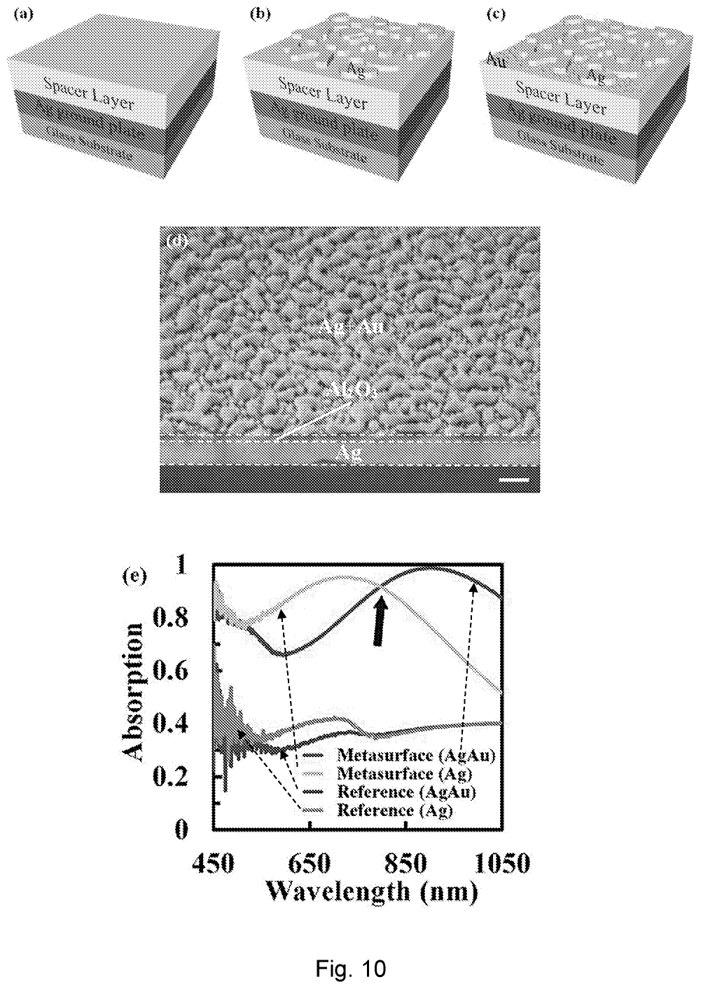

Nanofabrication: FIG. 10(a-c) illustrate the fabrication procedure: the three-layered super absorbing metasurface is composed of a 150-nm-thick Ag ground plate, a 50-nm-thick aluminum oxide (Al₂O₃) spacer layer and a layer of random metallic NPs. We first deposited a layer of Ag and Al₂O₃ spacer on a glass substrate (FIG. 10(a)). Following a lithography-free fabrication technique, direct deposition of Ag followed by thermal annealing was used to manipulate the average morphology (e.g., size, spacing) of the first layer of Ag NPs (FIG. 10(b)) to tune the effective optical constant and realize the desired light-trapping band. Next, a second Au film with the thickness of 5 nm was deposited on top of Ag NPs. The substrate was then annealed at 150° C. to further manipulate the NP size and inter-particle distance of Au NPs (FIG. 10(c)). This second step deposition and low temperature thermal annealing did not obviously change the morphology of the first layer Ag NPs treated under higher temperature. As shown by the scanning electronic microscope (SEM) image of the three-layered metafilm at a tilted angle (FIG. 10(d)), the second layer Au NPs were placed among the first layer of Ag NPs to shrink the nanogap.

The optical absorption of the hybrid Ag—Au metasurface was characterized using a microscopic Fourier transform infrared spectroscopy (Bruker, VETEX 70+Hyperion 1000). A strong absorption peak of 98.7% was obtained at the wavelength of 900 nm with the >90% absorption band spanning from 784 nm to 1030 nm (see the red curve in FIG. 10(e)), significantly broader than previously reported results. Compared with the metasurface without the second-step process (see the yellow curve in FIG. 10(e)), one can see a red shift in the absorption peak from 725 nm to 900 nm due to the change in thin film interference conditions. In addition, a single layer of Ag NPs and a single layer of Ag—Au. NPs on glass substrates were prepared as reference samples in the same film deposition and thermal annealing conditions. Their optical absorption spectra are plotted by the “Ref[32]” and “Ref[33]” curves in FIG. 10(e), showing only 29%˜42% throughout the measured spectral range. Based on this experimental characterization, one can see that after the second-step fabrication process, the metasurface structure still preserves the broadband light trapping feature with slightly shifted resonant wavelengths. These smaller gaps may obtain stronger localized field, which may enhance light-matter interaction (e.g., SERS and surface enhanced nonlinear optics), as will be discussed below.

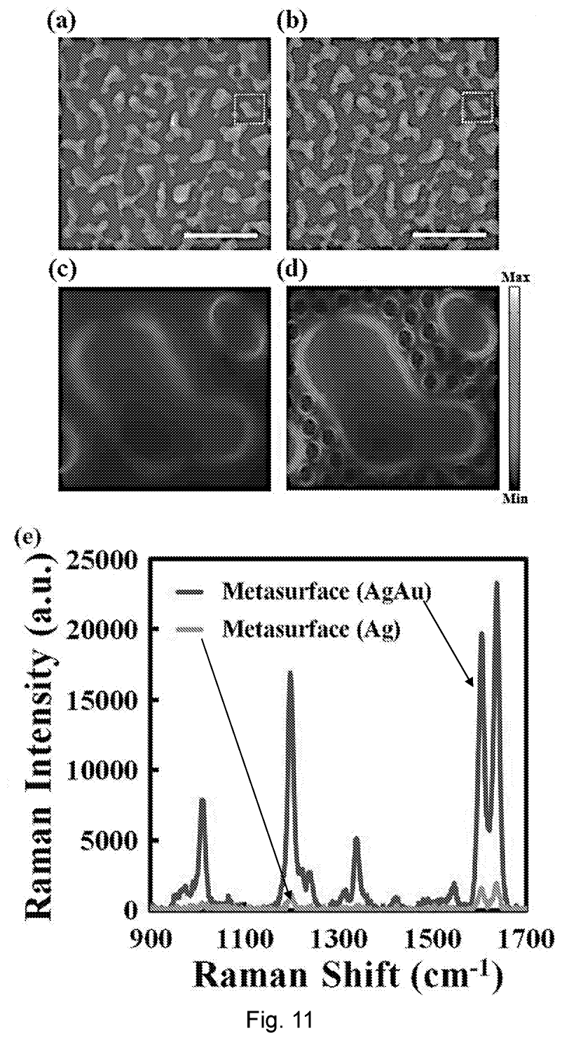

Structure characterization: To reveal the field localization feature, we focused on the wavelength at the intersection point between two absorption curves (see the widest arrow in FIG. 10(e)). At this wavelength (˜785 nm), the overall optical absorption of these two samples are similar (i.e., ˜90%). However, since the hybrid Ag—Au metasurface sample contains smaller gaps, more hot spots are expected with stronger localized field. To validate this prediction, we loaded a part of the SEM image of the top films shown in FIGS. 11(a) and 11(b) (i.e., the dotted squares) into the commercial software package, COMSOL, and modeled the spatial distribution of the electric field at λ=785 nm. As shown in FIGS. 11(c) and 11(d), the coverage area of hot spots increased from 13.6% to 21.6% (i.e., enhanced by 58.8%). More hot spots are obtained between large and small NPs, enabling more sensing areas with stronger localized field, which is highly desired for SERS sensing.

To demonstrate the localized field enhancement, we then employed this hybrid Ag—Au super absorbing metasurface in detecting 1,2-bis(4-pyridyl)-ethylene (BPE) molecules. Since BPE molecules include a highly delocalized 7c-electron system with chemically active pyridyl nitrogen atoms for binding to metal surfaces, they have been widely used as stable nonresonant probing molecules to evaluate the performance of SERS substrates and reveal the localized field enhancement effect. In this experiment, two metasurfaces without and with the second-step deposition process were both immersed in 1 mM BPE ethanolic solutions for 10 min and then air-dried. Next they were rinsed with pure ethanol. The SERS signals of these two samples were characterized using a bench-top confocal RENISHAW INVIA Raman microscope equipped with a 785 nm laser. As shown in FIG. 11(e), obvious Raman peaks at 1012, 1200, 1340, 1608, and 1637 cm⁻¹ were observed, which are signature “fingerprint” signals for BPE molecules. One can see that the Raman signal from the hybrid Ag—Au metasurface is much stronger than the metasurface with Ag NPs only, demonstrating the stronger electric field introduced by smaller gaps. Using this result, one can estimate the enhancement factor (EF) of both SERS metasurfaces without and with the second-step deposition process to be 4.7×10⁶ and 7.3×10⁷, respectively. Considering that the overall optical absorption of these two samples are similar (i.e., ˜90%), it indicates the further enhanced light-matter interaction by introducing smaller gaps over a large area.

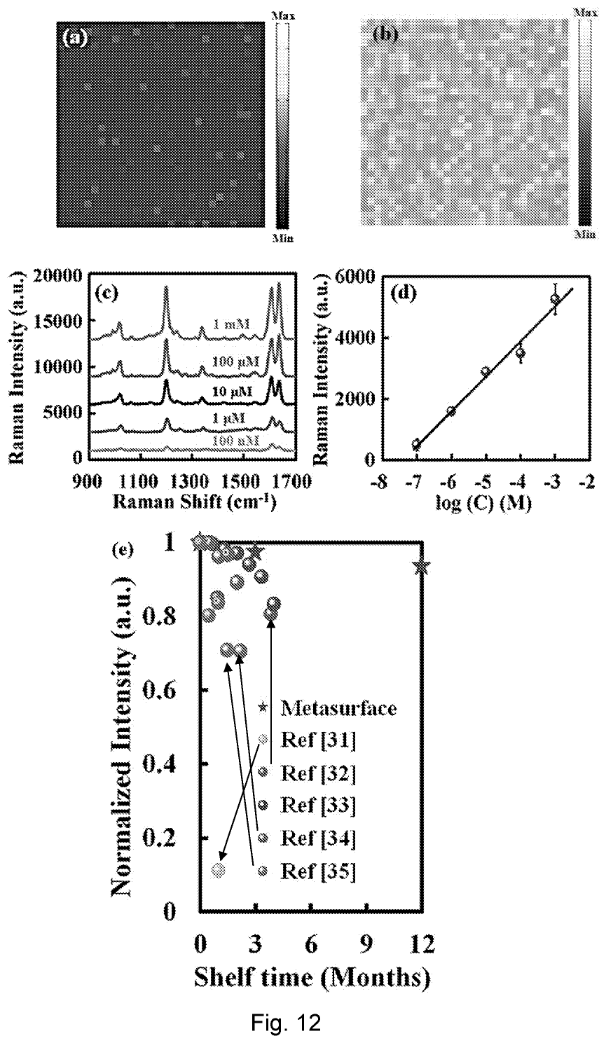

Spatial uniformity: As demonstrated in FIGS. 11(c) and 11(d), these hot spots supported by smaller gaps distribute more uniformly compared with the one with no second-step NPs. Therefore, the hybrid Ag—Au super absorbing metasurface with smaller gaps is promising to result in better spatial uniformity. In this experiment, a two-dimensional Raman mapping at the peak of 1608 cm⁻¹ was performed over a 30 μm×30 μm area with a step size of 1 μm. The relative standard deviations of Raman intensities of metasurfaces without (FIG. 12(a)) and with (FIG. 12(b)) the second-step deposition process are 8.14% and 5.89%, respectively, confirming the improved spatial uniformity introduced by the second-step NPs. This uniformity is comparable to SERS substrates with periodic patterns fabricated by expensive lithography methods (e.g., <10%) and may enable quantitative analysis. Realization of high resolution quantitative sensing via cost-effective chips is one of the grand challenges for SERS sensing. To evaluate the limit of detection of our metasurface chips, we placed 10 μL BPE ethanolic solutions onto the metasurface chips with the concentrations from 1 mM to 100 nM, then air-dried these chips. FIG. 12(c) exhibited the SERS spectra of BPE solutions with different concentrations. The signature Raman peaks of BPE were observable at the concentration of as low as 100 nM. By extracting the signal peak intensities at the specific Raman peak at 1608 cm⁻¹, one can reveal its linear relationship with the concentration of BPE ethanolic solution. As shown by the data fitting of the signal intensity at a selected peak at 1608 cm⁻¹ in FIG. 12(d), a linear correlation coefficient of 0.983 is achieved, suggesting its potential for quantitative SERS analysis.

Shelf-time: In practical applications (especially for commercial SERS chips), shelf-time is usually an important parameter: Due to the fragile nanostructure and stability issue of metal materials (e.g., Ag), the claimed shelf-time for most commercial SERS chips is relatively short. The performance of SERS chip may degrade over time, especially for Ag-based structures. For instance, the SERS intensity of silver nonarods substrates dropped nearly 80% after one week of storage in ambient environment (see dotted curves in FIG. 12(e)). For our proposed hybrid Ag—Au metasurface chip, the 2^{nd} layer of Au NPs cover the entire surface, including the larger Ag islands (FIG. 11(b)). Therefore, the oxidization of Ag surface was suppressed. In addition, as shown in FIG. 11(d), more hot spots were localized at edges of Au NPs while the overall light trapping performance did not change significantly. Therefore, the oxidization of Ag NP surfaces will not significantly affect the performance in SERS sensing. To reveal the shelf-time of our proposed structure, we stored the sample in a regular laboratory environment with the ambient temperature of 20˜23° C. and the humidity between 20% to 60%. To test its shelf-time, we prepared 1 mM BPE ethanolic solutions and followed the same sample preparation procedure to perform the characterization after 3-month and 12-month storage. As shown in FIG. 12(e), the degradation rate of the peak intensity at 1608 cm⁻¹ is less than 10%, which is much better than previously reported nanostructures (see data captured in FIG. 3(e)). This comparison demonstrated that the proposed Ag—Au metasurface kept effective after 1 year shelf-time in a regular storage environment. The final coating of the second Au nanoantenna layer improved the reliability of the chip.

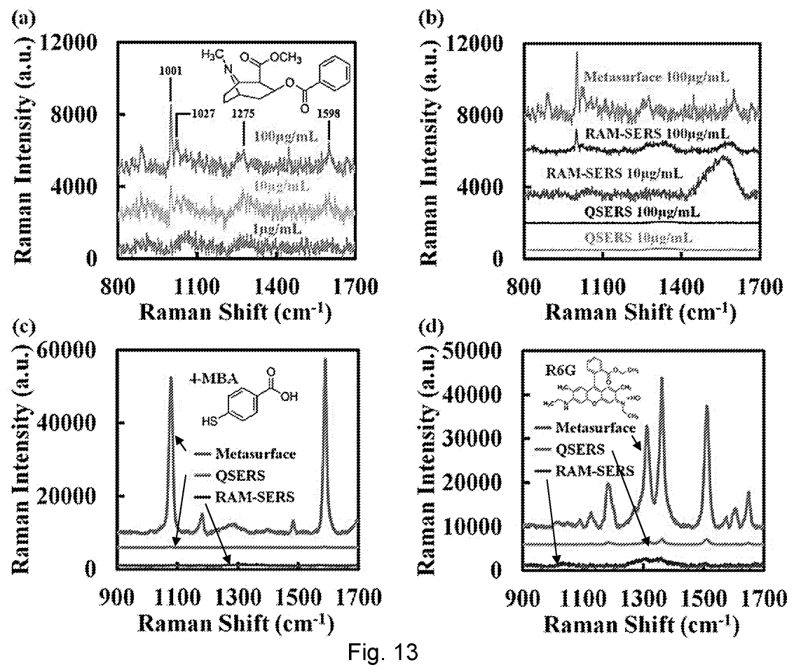

Applications: To demonstrate the practical application of the proposed hybrid metasurface SERS chip, we selected cocaine as the sensing target, which is one of the most important drugs related to forensic analysis. The widespread abuse of illicit drugs (e.g., cocaine, heroin, amphetamines, and hallucinogens) is a growing societal problem in the United States and many other countries. In clinical and forensic trace analysis, it is desired to develop a sensitive, reliable and fast sensing technology. In order to evaluate the limit of detection of the hybrid Ag—Au metasurface for drug sensing and potential forensic analysis, a series of low-concentration cocaine solutions were tested. In the experiment, we placed 10 μL cocaine acetonitrile solutions onto the metasurface chips with the concentrations from 100 μg/mL to 1 μg/mL, then air-dried these chips. As shown in FIG. 13(a), the vibrational modes of the cocaine molecules can be identified from the Raman spectra. The signature Raman peaks of cocaine at 1001 cm⁻¹ (i.e., the symmetric phenyl ring breathing mode), 1027 cm⁻¹ (i.e., the asymmetric phenyl ring breathing mode), 1275 cm⁻¹ (i.e., the C-phenyl stretch), and 1598 cm⁻¹ (i.e., the trigonal phenyl ring breathing mode) are observable at the concentration of as low as 10 μg/mL. Considering the droplet volume of 10 μL and the coverage area of ˜20 mm² on the metasurface, the averaged density of cocaine on the metasurface was only 5 ng/mm², which is much better than previously reported results (e.g., 0.2 μg/mm², ˜446 ng/mm², 314 ng/mm², and 1.9 μg/mm²). For another comparison, two commercial substrates (i.e., QSERS and RAM-SERS) were prepared under the same procedure and measured using identical experimental conditions, as shown in FIG. 13(b). One can see that only the concentration of 100 μg/mL can be observed using the commercial RAM-SERS substrate. The other commercial chip, QSERS substrate, cannot detect these cocaine solutions. This comparison clearly demonstrated the improved sensing performance of the proposed hybrid Ag—Au metasurface chip with smaller nanogaps.

Finally, we further explored the superior sensing capability based on surface chemical properties of Au and Ag NPs. For instance, it is known that the thiol-Au chemical binding is much stronger than the thiol-Ag binding. The thiol group is a typical group of chemical molecules containing a sulfur atom and a hydrogen atom (i.e., —SH). In surface treatment of substrates for many bio/chemical investigations, thiol functional group molecules are widely used as building blocks. In addition, the detection and measurement of free thiols (i.e., free cysteine, glutathione, and cysteine residues on proteins, etc.) is one of the essential tasks for investigating biological processes and events in many biological systems. Therefore, the proposed hybrid Ag—Au metasurface structure is promising to realize unique sensing capabilities for specific bio/chemical molecules with thiol groups.

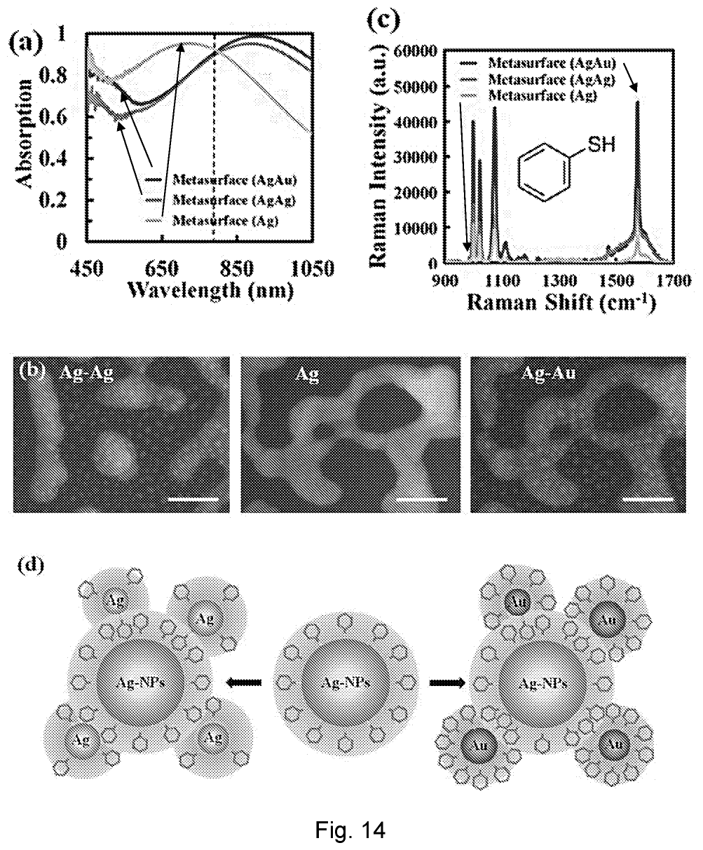

To demonstrate the potential enhancement effect of Au—S binding, in this experiment, we employed benzenethiol (BZT) molecules as the probe and developed three different metasurface chips for comparison. BZT is one of the simplest aromatic thiols with four obvious Raman peaks at 1000, 1022, 1076, and 1576 cm⁻¹ which are relatively easy to recognize. When BZT molecules adsorb to the nanostructured chip, the sulfur atoms are strongly bounded to the metal surface and form benzenethiolate. To ensure a complete self-assembled monolayer (SAM) of BZT formed on the substrate surface, three metasurface substrates were immersed in 100 μM BZT ethanolic solutions for 1 hour and were subsequently rinsed with pure ethanol before air-drying. In this experiment, three metasurface chips without and with the second-step NPs deposition process were fabricated: i.e., single-Ag, Ag—Ag and Ag—Au metasurface chips. These three types of structures were fabricated starting from the same first-step deposition of Ag nanopatterns. Next, the second layer of Ag film and Au film with the same thicknesses (i.e., 5 nm) were deposited on top of the first layer Ag NPs, respectively. Then both substrates were annealed at 150° C. to adjust NP sizes and inter-particle distances. Their optical absorption spectra are plotted in FIG. 14 (a), showing that all three samples have similar optical absorption at the wavelength of 785 nm (in particular, the absorption of the metasurface with a single layer Ag NPs is slightly higher). As shown in FIG. 14(b), the second layer of Ag and Au NPs with similar sizes were inserted among the first layer Ag NPs, realizing smaller nanogaps. Their SERS signals were characterized under identical conditions using the excitation laser at 785 nm. As shown in FIG. 14(c), obvious Raman peaks at 1000, 1022, 1076, and 1576 cm⁻¹ were observed, corresponding to signature “fingerprint” signals of BZT molecules. One can see that the Raman signal from the hybrid Ag—Au metasurface is stronger than the other two metasurfaces, which should be attributed to the stronger Au—S binding as illustrated in FIG. 14(d). According to the second-order Moller-Plesset perturbation theory (MP2) and density functional theory (DFT), the thiols-Au bond is stronger than that with Ag. In addition, the density of thiol chains of the SAM on Au surfaces is larger than that on Ag substrates. In this case, more BZT molecules can adsorb to the surface of Au NPs with a better interaction with the localized field, resulting in the stronger SERS signal.

As shown in FIG. 15, by extracting the signal intensities of all five specific Raman peaks at 1012, 1200, 1340, 1608, and 1637 cm⁻¹, one can reveal their linear relationships with the concentration of BPE ethanolic solutions. As shown by the data fitting of the signal intensities in FIG. 15 the results are consistent at different Raman peaks. The linear correlation coefficients of 0.935. 0.995, 0.998, 0.983, and 0.979 are achieved, suggesting its potential for quantitative SERS analysis. It should be noted that the linear con-elation coefficient at the peak of 1012 cm⁻¹ is slightly smaller due to the relatively low Raman intensity and signal-to-noise ratio at this peak.

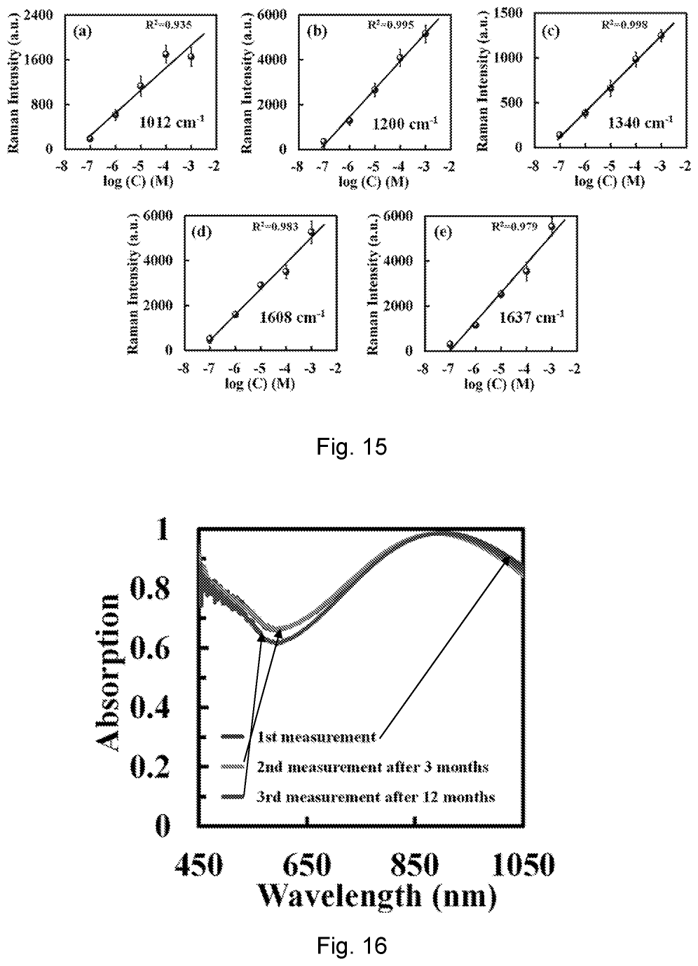

As shown in FIG. 16, after 12-month storage in regular environment in the laboratory, we did not observe significant change in the absorption spectrum. Especially, the absorption at the excitation wavelength of 785 nm is almost unchanged, indicating the stable light trapping performance and sensing performance for SERS. In addition, as shown in FIGS. 11(c) and 11(d), more hot spots are localized at edges of Au NPs, suggesting that the major contribution of SERS signal was from molecules near these Au NPs.

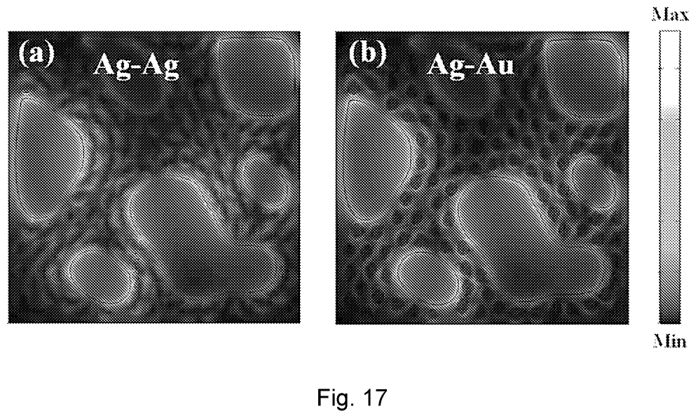

The simulation was performed to compare an Ag—Au metasurface with an Ag—Ag metasurface. Since the second layers of Ag and Au NPs showed similar sizes in FIG. 14(b), here we employed the same model by changing the materials (i.e. Au or Ag) for smaller NPs. As shown in FIG. 17, the hot spot distributions of both metasurfaces are similar, confirming that the plasmonic coupling will not be affected much when the material composition changes from Ag—Au to Ag—Ag. Therefore, the increased Raman signal from the hybrid Ag—Au metasurface should only be attributed to the molecular binding to the surface.

In conclusion, we developed a scalable and cost-effective super absorbing metasurface substrate that can localize electromagnetic field at edges of nanopatterns by introducing a second-step metal NP deposition process. This unique feature of localized field enhancement was validated through SERS sensing experiments. Further, since more hot spots were excited around extra smaller NPs over a given area, the spatial distribution of localized field is more uniform. Cocaine was selected as the sensing target to demonstrate the practical application of the proposed hybrid metasurface substrate in clinical and forensic trace analysis. Furthermore, the second-step coating of smaller Au NPs improved the reliability of the chip, which was demonstrated effective after 1 year shelf-time in regular storage environment. The superior feature reported by this article paved the way towards more affordable and quantitative sensing using SERS technology. Particularly, due to stronger thiol-Au binding and higher density of thiol chains on Au surfaces, the proposed hybrid Ag—Au metasurface structure may realize unique capabilities for sensing of bio/chemical molecules with thiol groups. More importantly, this efficient light trapping metasurface structure is completely lithography free, suitable for large area manufacturing (including roll-to-roll processes). It will accelerate the development of low-cost high-performance SERS chips for portable Raman spectroscopy systems.

The steps of the method described in the various embodiments and examples disclosed herein are sufficient to carry out the methods of the present invention. Thus, in an embodiment, the method consists essentially of a combination of the steps of the methods disclosed herein. In another embodiment, the method consists of such steps.

Although the present disclosure has been described with respect to one or more particular embodiments, it will be understood that other embodiments of the present disclosure may be made without departing from the scope of the present disclosure.

What is claimed is:

1. A method for manufacturing a substrate for Surface-Enhanced Raman Spectroscopy (SERS), the method comprising:
providing a ground plate;
providing a spacer layer on the ground plate;
forming a first plurality of metallic nanostructures on the spacer layer such that a portion of the spacer layer is exposed in gaps formed between the nanostructures of the first plurality of metallic nanostructures;
forming a second plurality of metallic nanostructures on the spacer layer in the gaps of the first plurality of metallic nanostructures.

2. The method of claim 1, wherein the ground plate is disposed on a substrate.

3. The method of claim 2, wherein the substrate is generally smooth.

4. The method of any one of claim 2 or 3, wherein the substrate comprises glass, metal, silicon, or plastic.

5. The method of any one of claims 1-4, wherein the ground plate is reflective.

6. The method of any one of claims 1-4, wherein the ground plate comprises a metal.

7. The method of claim 6, wherein the metal comprises a noble metal.

8. The method of claim 7, wherein the noble metal comprises silver, gold, or aluminum.

9. The method of any one of claims 1-8, wherein the ground plate is optically thick.

10. The method of any one of claims 1-9, wherein the spacer layer comprises a low-loss dielectric.

11. The method of claim 10, wherein the low-loss dielectric comprises aluminum oxide, titanium dioxide, or silicon dioxide.

12. The method of any one of claim 10 or 11, wherein the low-loss dielectric is configured to transmit more than 80% of incident light.

13. The method of any one of claims 1-12, wherein the spacer layer has an average thickness from 10 nm to 100 nm, inclusive.

14. The method of claim 13, wherein the average thickness of the spacer layer is 50 nm.

15. The method of any one of claims 1-14, wherein the first plurality of metallic nanostructures comprise a material configured for localized surface plasmon resonance.

16. The method of claim 15, wherein the material comprises silver, gold, or palladium.

17. The method of any one of claims 1-16, wherein forming the first plurality of metallic nanostructures on the spacer layer comprises:
depositing a first metallic layer on the spacer layer; and
annealing the first metallic layer at a temperature such that the first metallic layer is transformed into the first plurality of metallic nanostructures disposed on the spacer layer thereby exposing the portion of the spacer layer.

18. The method of claim 17, wherein the first metallic layer comprises silver and the temperature is 200° C.

19. The method of any one of claims 1-16, wherein forming the first plurality of metallic nanostructures on the spacer layer comprises depositing the first plurality of nanostructures on the spacer layer to an average thickness ranging from 5 nm to 8 nm, inclusive.

20. The method of any one of claims 1-19, wherein the first plurality of metallic nanostructures has an average thickness of 12 nm.

21. The method of any one of claims 1-20, wherein the gaps are approximately 0.5 nm to 0.8 nm.

22. The method of any one of claims 1-21, wherein forming the second plurality of metallic nanostructures comprises:
depositing a second metallic layer on the first plurality of metallic nanostructures and the exposed portion of the spacer layer; and
annealing the second metallic layer at a temperature such that the second metallic layer is transformed into the second plurality of metallic nanostructures disposed in the gaps of the first plurality of nanostructures.

23. The method of claim 22, wherein the second metallic layer comprises gold and the temperature is 150° C.

24. The method of any one of claim 22 or 23, wherein the second metallic layer has an average thickness of 5 nm.

25. The method of any one of claims 1-24, wherein the material of the first plurality of metallic nanostructures is different than the material of the second plurality of metallic nanostructures.

26. A structure for Surface-Enhanced Raman Spectroscopy (SERS), comprising:
a ground plate;
a spacer layer disposed on the ground plate;
a first plurality of metallic nanostructures disposed on the spacer layer such that a portion of the spacer layer is exposed in gaps formed between the nanostructures of the first plurality of metallic nanostructures; and
a second plurality of metallic nanostructures disposed on the spacer layer in the gaps of the first plurality of metallic nanostructures.

27. The structure of claim 26, wherein the ground plate is disposed on a substrate

28. The structure of claim 27, wherein the substrate is generally smooth.

29. The structure of any one of claim 27 or 28, wherein the substrate comprises glass, metal, silicon, or plastic.

30. The structure of any one of claims 26-29, wherein the ground plate is reflective.

31. The structure of any one of claims 26-30, wherein the ground plate comprises a metal.

32. The structure of claim 31, wherein the metal comprises a noble metal.

33. The structure of claim 32, wherein the noble metal comprises silver, gold, or aluminum.

34. The structure of any one of claims 26-33, wherein the ground plate is optically thick.

35. The structure of any one of claims 26-34, wherein the spacer layer comprises a low-loss dielectric.

36. The structure of claim 35, wherein the low-loss dielectric comprises aluminum oxide, titanium dioxide or silicon dioxide.

37. The structure of any one of claim 35 or 36, wherein the low-loss dielectric is configured to transmit more than 80% of incident light.

38. The structure of any one of claims 26-37, wherein the spacer layer has an average thickness from 10 nm to 100 nm, inclusive.

39. The structure of claim 38, wherein the average thickness of the spacer layer is 50 nm.

40. The structure of any one of claims 26-39, wherein the first plurality of metallic nanostructures comprise a material configured for localized surface plasmon resonance.

41. The structure of any one of claim 40, wherein the material comprises silver, gold, or palladium.

42. The structure of any one of claims 26-41, wherein the first plurality of metallic nanostructures has an average thickness ranging from 5 nm to 8 nm, inclusive.

43. The structure of any one of claims 26-41, wherein the first plurality of metallic nanostructures has an average thickness of 12 nm.

44. The structure of any one of claims 26-43, wherein the gaps are approximately 0.5 nm to 0.8 nm.

45. The structure of any one of claims 26-44, wherein the first plurality of metallic nanostructures has an average morphology having a pre-determined effective optical constant and light-trapping band.

46. The structure of claim 45, wherein the pre-determined effective optical constant is configured such that the first plurality of metallic nanostructures is configured to absorb more than 90% of light having wavelengths in the range of 784 nm to 1030 nm, inclusive.

47. The structure of any one of claims 26-46, wherein the material of the first plurality of metallic nanostructures is different than the material of the second plurality of metallic nanostructures.

48. A SERS system comprising the structure of any one of claims 1-47.

49. The SERS system of claim 49, wherein the structure is configured for the detection of a drug or a virus.

50. The SERS system of any one of claim 48 or 49, wherein the structure is configured as a flow-through sensor.

51. A method for manufacturing a Surface-Enhanced Raman Spectroscopy (SERS) nanostructure, comprising:
forming a first plurality of metallic nanostructures on a substrate such that a portion of the substrate is exposed in gaps formed between the nanostructures of the first plurality of metallic nanostructures;
conformally coating the first plurality of metallic nanostructures with a spacer layer; and
depositing a metallic layer on the spacer layer.

52. The method of claim 51, wherein the substrate is generally smooth.

53. The method of any one of claim 51 or 52, wherein the substrate comprises glass, metal, silicon, or plastic.

54. The method of any one of claims 51-53, wherein forming the first plurality of metallic nanostructures on the substrate comprises:
depositing a metal on the substrate; and
annealing the deposited metal at a temperature to form the first plurality of metallic nanostructures.

55. The method of claim 54, wherein the metal is deposited to an average thickness from 10 nm to 15 nm, inclusive.

56. The method of claim 55, wherein the average thickness is 12 nm.

57. The method of any one of claims 54-56, wherein depositing the metal on the substrate comprises electron-beam evaporation.

58. The method of any one of claims 54-57, wherein the temperature is 300° C.

59. The method of any one of claims 51-58, wherein the first plurality of metallic nanostructures comprise a material configured for localized surface plasmon resonance.

60. The method of claim 59, wherein the material comprises silver, gold, or palladium.

61. The method of any one of claims 51-60, wherein the first plurality of metallic nanostructures has an average thickness of 12 nm.

62. The method of any one of claims 51-61, wherein the gaps are approximately 0.5 nm to 0.8 nm.

63. The method of any one of claims 51-62, wherein the spacer layer comprises a low-loss dielectric.

64. The method of claim 63, wherein the low-loss dielectric comprises aluminum oxide, titanium dioxide, or silicon dioxide.

65. The method of any one of claim 63 or 64, wherein the low-loss dielectric is configured to transmit more than 80% of incident light.

66. The method of any one of claims 51-65, wherein the spacer layer has an average thickness from 10 nm to 100 nm, inclusive.

67. The method of claim 66, wherein the average thickness of the spacer layer is 50 nm.

68. The method of any one of claims 51-67, wherein the metallic layer comprises a noble metal.

69. The method of claim 68, wherein the noble metal comprises silver, gold, or aluminum.

70. The method of any one of claims 51-69, further comprising template stripping the SERS nanostructure from the substrate.

71. The method of claim 70, wherein template stripping comprises:
applying a UV-curable optical adhesive to the metallic layer;
covering the UV-curable optical adhesive with a glass slide;
curing the UV-curable optical adhesive; and
removing the SERS nanostructure from the substrate.

72. The method of any one of claims 51-71, wherein the spacer layer has an average thickness less than 2 nm.

73. The method of claim 72, wherein the average thickness of the spacer layer is from 0.3 nm to 1 nm, inclusive.

74. The method of any one of claims 51-73, wherein conformally coating the first plurality of metallic nanostructures with the spacer layer comprises atomic layer deposition.

75. The method of any one of claims 51-74, wherein the metallic layer has an average thickness of 10 nm.

76. A Surface-Enhanced Raman Spectroscopy (SERS) substrate, comprising:
a nanoporous dielectric layer comprising a plurality of nanopores having sidewalls, and
a plurality of metallic nanostructures disposed on at least a portion of the sidewalls of the plurality of nanopores such that a portion of the dielectric layer is exposed in gaps formed between the nanostructures of the first plurality of metallic nanostructures.

77. The SERS substrate of claim 76, where the nanoporous dielectric layer is an anodic aluminum oxide membrane.

78. The SERS substrate of any one of claims 76 and 77, wherein the plurality of metallic nanostructures comprise a noble metal.

79. The SERS substrate of claim 78, wherein the noble metal comprises silver, gold, or aluminum.

80. The SERS substrate of any one of claims 76-78, wherein each of the nanopores in the plurality of nanopores has a diameter of between 50 nm and 400 nm, inclusive.

81. The SERS substrate of any one of claim 76-78 or 80, wherein the nanoporous dielectric layer has a periodicity of between 10 nm and 700 nm, inclusive.

82. The SERS substrate of any one of claim 76-78 or 80-81, further comprising a hydrophobic coating.

83. The SERS substrate of claim 82, wherein the hydrophobic coating is polytetrafluoroethylene.

84. A SERS system, comprising the SERS substrate of any of claims 76-83.

85. The SERS system of claim 84, wherein the SERS substrate is configured for the detection of a drug or a virus.

86. The SERS system of any one of claims 84 and 85, wherein the SERS substrate is configured as a flow-through sensor.
